(19) United States
(12) Patent Application Publication
(10) Pub. No.: US 2018/0033053 A1
(43) Pub. Date: Feb. 1, 2018

(54) METHOD AND SYSTEM FOR FACILITATING COMMUNICATIONS ACCORDING TO INTERACTION PROTOCOLS

(71) Applicant: LIVEPERSON, INC., New York, NY (US)

(72) Inventors: Matan Barak, Ra'anana (IL); Shlomi Schwartz, Sh'faim (IL)

(73) Assignee: LIVEPERSON, INC., New York, NY (US)

(21) Appl. No.: 15/632,069

(22) Filed: Jun. 23, 2017

Related U.S. Application Data
(63) Continuation-in-part of application No. 13/961,072, filed on Aug. 7, 2013, now abandoned.

(51) Int. Cl. G06Q 30/02; G06Q 50/00; G06F 3/048

(52) U.S. Cl. CPC G06Q 30/0271; G06F 3/048; G06Q 50/01

(57) ABSTRACT

This disclosure presents methods, systems, computer-readable media, for facilitating communications according to interaction protocols. The techniques generally involve displaying an interface, tracking user interactions with the interface, generating possible interaction protocols for communication with a user, and selectively communicating with users based on one or more interaction protocols. Users may be provided with an interactive application download which enables user browsing activities to be tracked in greater detail, and enables users to be selectively chosen to receive communications from a terminal device. User behavior is estimated and protocols for communicating with users are continuously evaluated for potential use based on the estimates.

### TECHNICAL FIELD

The present disclosure relates to generally to facilitating routing of communications. More specifically, techniques are provided to facilitate communications with user devices according to interaction protocols.

### BACKGROUND

The number of electronic or telephonic communications being generated is growing at an unprecedented rate. Various devices can facilitate in providing responses to such communications. However, the quality and speed of such responses can vary across devices. Further, while one device may be configured to provide a relative high-quality and fast response to one communication, a different device may be configured to provide such a relative high-quality and fast response to another communication. Accordingly, it is important to promote strategic routing of communications to users.

### BRIEF SUMMARY

This disclosure provides techniques for using social-networks to enable intelligent gathering and analysis of data to dynamically identify interaction protocols (e.g., strategies).

Certain networking platforms (e.g., social networks) connect large groups of users. Users of these networking platforms commonly maintain a profile page. This disclosure provides techniques with which information shared by a user (or a connection of that user) can be analyzed to determine interaction protocols for communicating with the user.

In some embodiments, a computer-implemented method may be provided. The computer-implemented method may include accessing an interface (e.g., fan page). The interface may be configured to interact with one or more profiles (e.g., users). Further, a profile may be associated with a social media network (e.g., FACEBOOK). The method may also include detecting an interaction between the interface and a profile. The profile may indicate a connection to one or more additional profiles (e.g., friends or followers). Further, the method may include accessing activity data associated with the one or more additional profiles. The activity data may be associated with an attribute (e.g., a characteristic of a profile or a user, such as location of the user) corresponding to the one or more additional profiles. The attribute may be associated with the social media network (e.g., data received at the social media network, such as input received from a user device). In addition, the method may include determining an interaction protocol using the activity data. The interaction protocol may be configured to increase a likelihood of an outcome. For example, the outcome may target an additional profile of the one or more additional profiles. The additional profile that is targeted may be associated with the attribute. The method may also include facilitating a communication according to the interaction protocol. In some embodiments, the interaction protocol may indicate the manner in which a communication is generated and transmitted to the additional profile.

In some embodiments, a system may be provided. The system may include one or more data processors; and a non-transitory computer-readable storage medium containing instructions which, when executed on the one or more data processors, cause the one or more data processors to perform the method(s) described above and herein. In some embodiments, a computer-program product tangibly embodied in a non-transitory machine-readable storage medium may be provided. The non-transitory machine-readable storage medium may include instructions configured to cause a data processing apparatus to perform the method(s) described above and herein.

### BRIEF DESCRIPTION OF THE DRAWINGS

The present disclosure is described in conjunction with the appended figures:

FIG. 1 shows a block diagram of an embodiment of a network interaction system;

FIG. 2 shows a block diagram of another embodiment of a network interaction system;

FIGS. 3A-3C show block diagrams of other embodiments of a network interaction system that includes a connection system;

FIG. 4 shows a representation of a protocol-stack mapping of connection components' operation;

FIG. 5 represents a multi-device communication exchange system according to an embodiment;

FIG. 6 shows a block diagram of an embodiment of a connection system;

FIG. 7 is a diagram depicting example components used in accordance with the embodiments of the present disclosure.

FIG. 8 is a screenshot depicting an example user communication interface provided in accordance with certain techniques disclosed herein.

FIG. 9 is a screenshot depicting an example interface provided in accordance with certain techniques disclosed herein.

FIG. 10 depicts example communication server operations in accordance with the present disclosure.

FIG. 11 depicts example communication server operations in accordance with the present disclosure.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides examples of embodiment(s) only and is not intended to limit the scope, applicability or configuration of the disclosure. Rather, the ensuing description of the examples of embodiment(s) will provide those skilled in the art with an enabling description for implementing examples of embodiment. It is understood that various changes can be made in the function and arrangement of elements without departing from the spirit and scope as set forth in the appended claims.

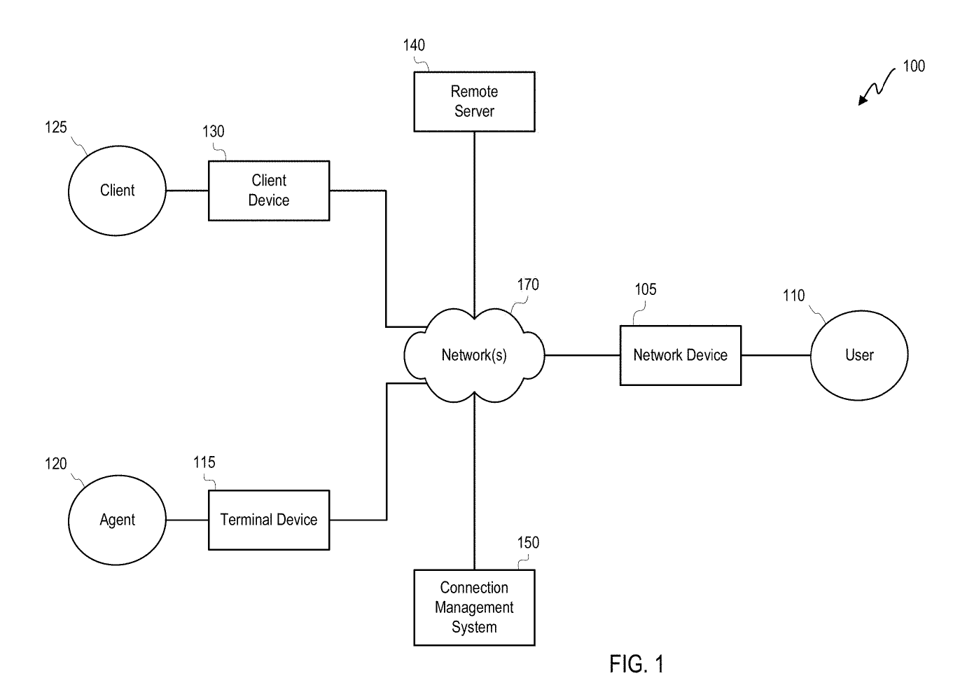

FIG. 1 shows a block diagram of an embodiment of a network interaction system 100 which implements and supports certain embodiments and features described herein. Certain embodiments relate to establishing a connection channel between a network device 105 (which can be operated by a user 110) and a terminal device 115 (which can be operated by an agent 120, such as a human agent or a bot agent). In certain embodiments, the network interaction system 100 can include a client device 130 associated with a client 125.

In certain embodiments, a user 110 can access remote server 140 to interact with an interface. A client 125 can be an entity that provides, operates, or runs the network site, or agents employed by or assigned by such an entity to perform the tasks available to a client 125 as described herein. The agent 120 can be a person, such as a support agent tasked with providing support or data to the user 110 regarding the network site (e.g., data about objects available for assignment over a network). Out of a large number of agents, a subset of agents may be appropriate for providing support or data for a particular client 125. The agent 120 may be affiliated or not affiliated with the client 125. Each agent can be associated with one or more clients 125. In some non-limiting examples, a user 110 can access a network site using a user device (e.g., a smartphone, an electronic computing device, an electronic computing device, and other suitable computing devices), a client 125 can be a company that provides objects to be assigned to users that meet certain conditions (e.g., pays a specific price), and an agent 120 can be an agent that is associated with the company. In various embodiments, the user 110, client 125, and agent 120 can be other users or entities.

While FIG. 1 shows only a single network device 105, terminal device 115 and client device 130, an interaction system 100 can include multiple or many (e.g., tens, hundreds or thousands) of each of one or more of these types of devices. Similarly, while FIG. 1 shows only a single user 110, agent 120 and client 125, an interaction system 100 can include multiple or many of each of one or more of such entities. Thus, it may be necessary to determine which terminal device is to be selected to communicate with a particular network device. Further complicating matters, a remote server 140 may also be configured to receive and respond to select network-device communications.

A connection system 150 can facilitate strategic routing of communications. A communication can include a message with content (e.g., defined based on input from an entity, such as typed or spoken input). The communication can also include additional data, such as data about a transmitting device (e.g., an IP address, user identifier, device type and/or operating system); a destination address; an identifier of a client; an identifier of an interface or interface element (e.g., a network site or network site element being visited when the communication was generated or otherwise associated with the communication); a time (e.g., time of day); and/or destination address. Other data can be included in the communication. In some instances, connection system 150 routes the entire communication to another device. In some instances, connection system 150 modifies the communication or generates a new communication (e.g., based on the initial communication). The new or modified communication can include the message (or processed version thereof), at least some (or all) of the additional data (e.g., about the transmitting device, network interface and/or time) and/or other data identified by connection system 150 (e.g., user data associated with a particular user identifier or device). The new or modified communication can include other data as well.

Part of strategic-routing facilitation can include establishing, updating and using one or more connection channels between network device 105 and one or more terminal devices 115. For example, upon receiving a communication from network device 105, connection system 150 can first estimate to which client (if any) the communication corresponds. Upon identifying a client, connection system 150 can identify a terminal device 115 associated with the client for communication with network device 105. In some instances, the identification can include evaluating a protocol (e.g., profile) of each of a plurality of agents, each agent (e.g., agent 120) in the plurality of agents being associated with a terminal device (e.g., terminal device 115). The evaluation can relate to a content in a network-device message. The identification of the terminal device 115 can include a technique described, for example, in U.S. application Ser. No. 12/725,799, filed on Mar. 17, 2010, which is hereby incorporated by reference in its entirety for all purposes.

In some instances, connection system 150 can determine whether any connection channels are established between network device 105 and a terminal device associated with the client (or remote server 140) and, if so, whether such channel is to be used to transmit and receive a series of communications including the communication or message. This determination may depend, at least in part, on a topic associated with the communication, a polarity parameter (e.g., a sentiment score or value) associated with the communication or a past related communication, an estimated response latency for terminal device 115 and/or a type of communication channel associated with the communication (e.g., instant message, message, email, phone). Selecting an established communication channel may reduce the need to relay data from network device 105 multiple times. Meanwhile, determining that a new communication channel is to be established can facilitate quicker responses from more specialized agents.

A decision as to whether to select (or continue to use) an established communication channel and/or a selection of a new terminal device can include determining an extent to which each of one or more terminal devices (e.g., associated with a client) corresponds to a communication and/or an associated the user. Such correspondence can relate to, for example, an extent to which an agent's resource set (e.g., knowledge base) corresponds to a communication topic, an availability of an agent at a particular time and/or over a channel type, a language similarity between a user and agent.

Connection system 150 may use communication analyses to influence routing determinations (e.g., determining whether to route a communication to a terminal device having previously received a communication from a network device having transmitted the communication or selecting a terminal device to receive or transmit a communication). One communication analysis can include determining one or more types or tags of a current or past communication or communication series. For example, a communication can be assigned a type for each of (for example) a topic, channel type (e.g., email, SMS message, real-time communication, phone call or asynchronous message), complexity level, message polarity, and/or whether/which file type is attached, and a terminal-device selection can be biased towards terminal devices associated with similar or related types.

Upon selecting a terminal device 115 to communicate with network device 105, connection system 150 can establish a connection channel between the network device 105 and terminal device 115. In some instances, connection system 150 can transmit a message to the selected terminal device 115. The message may request that the terminal device approve a proposed assignment to communicate with a network device 105 or identify that such an assignment has been generated. The message can include data about network device 105 (e.g., IP address, device type, and/or operating system), data about an associated user 110 (e.g., language spoken, duration of having interacted with client, skill level, and/or topic preferences), a received communication, code (e.g., a clickable hyperlink) for generating and transmitting a communication to the network device 105, and/or an instruction to generate and transmit a communication to network device 105.

In one instance, communications between network device 105 and terminal device 115 can be routed through connection system 150. Such a configuration can allow connection system 150 to monitor the transmitting and/or receiving of communications or messages and to detect issues (e.g., as defined based on rules) such as non-responsiveness of either device or extended latency. Further, such a configuration can facilitate selective or complete storage of communications, which may later be used, for example, to determine a quality of a communications between network devices and terminal devices and/or to support learning to update or generate routing rules so as to determine particular post-communication targets. Such storage can also facilitate generation of a series of previous messages (e.g., a message history or chronicle) between a network device and first terminal device, which may be transmitted (for example) to a second terminal device when it is determined that the second terminal device is to join an existing or participate in a new communication series with the network device.

In some embodiments, connection system 150 can monitor the transmitting and receiving of communications in real-time and perform automated actions (e.g., rule-based actions) based on the live communications. For example, when connection system 150 determines that a communication relates to a particular object, connection system 150 can automatically transmit an additional message to terminal device 115 containing additional data about the object (e.g., quantity of objects available, other data about the similar objects, etc.).

In one instance, a designated terminal device 115 can communicate with network device 105 without relaying communications through connection system 150. One or both devices 105, 115 may (or may not) report particular communication metrics or content to connection system 150 to facilitate communication monitoring and/or data storage.

As mentioned, connection system 150 may route select communications to a remote server 140. Remote server 140 can be configured to provide data in a predetermined manner. For example, remote server 140 may access defined one or more text passages, voice recording and/or files to transmit in response to a communication. Remote server 140 may select a particular text passage, recording or file based on, for example, an analysis of a received communication (e.g., a semantic or mapping analysis).

Routing and/or other determinations or processing performed at connection system 150 can be performed based on rules and/or data at least partly defined by or provided by one or more client devices 130. For example, client device 130 may transmit a communication that identifies a prioritization of agents, terminal-device types, and/or topic similarity. As another example, client device 130 may identify one or more weights to apply to various variables that may impact routing determinations (e.g., estimated response time, device type and capabilities, and/or terminal-device load balancing). It will be appreciated that which terminal devices and/or agents are to be associated with a client may be dynamic. Communications from client device 130 and/or terminal devices 115 may provide data indicating that a particular terminal device and/or agent is to be added or removed as one associated with a client. For example, client device 130 can transmit a communication with IP address and an indication as to whether a terminal device with the address is to be added or removed from a list identifying client-associated terminal devices.

In one instance, connection system 150 facilitates an initial connection and routing between network device 105 and a first terminal device 115. For example, a message received in a communication from network device 105 can be routed to the first terminal device. As another example, communication system 150 can transmit a communication to the first terminal device that includes or is indicative of a request or instruction to transmit a communication (e.g., initiating a communication series) to network device 105.

Connection system 150 can monitor and/or analyze a corresponding communication series between network device 105 and the first terminal device to determine a characteristic. For example, connection system 150 can analyze message content in one or more communications (e.g., to determine whether and/or how many of particular words, symbols or character types, such as “frustrat*”, “very”, “thank”, or “irritat*”, “!” or capital letters, were used). As another example, connection system 150 can determine one or more statistics relating to each of one or more messages and/or the series. Examples of statistics can include, for example, message length (e.g., in words or characters), latency between a receipt of a communication and transmission of a responsive communication, latency between subsequent message transmissions, or typing speed while typing a message. As yet another example, connection system 150 can receive and process one or more inputs, detected initially at network device 105 or the first terminal device and then identified to connection system 150. Such inputs can identify, for example, a reroute request, or a resolution stage.

Connection system 150 can evaluate the characteristic (e.g., characterizing message content, including a statistic or characterizing an input) to determine whether to define subsequent routing rules in a particular manner. For example, a continuous-channel rule can include a condition relating to a characteristic that specifies when routing of network-device messages is to be inclined towards the first terminal device (which previously communicated with the network device). The rule can be configured such that satisfaction of the condition results in establishment of a continuous channel between the network device and the first terminal device. The continuous channel can allow subsequent messages from the network device to be automatically routed to the first terminal device and/or preferentially routed to the first terminal device. The continuous channel can be configured to persist through multiple communication series. For example, even if a first series of messages are communicated between the network device and first terminal device on a first day, the channel can inclination routing of another message from the network device transmitted on a second day to be routed to the same first terminal device. A magnitude of such inclination may depend on, for example, a time since a previous interaction between the network device and first terminal device (e.g., increasing the level of inclination when a past interaction was recent), a total duration of and/or number of communications in a previous conversation (e.g., series of messages communicated between the network device and first terminal device) and/or a number of previous messages communicated between the network device and first terminal device (and/or a cumulative interaction time or count of messages).

Upon establishing a continuous channel, connection system 150 can further facilitate presenting a presentation (e.g., notification) at network device 105 so as to alert user 110 that a continuous channel has been established, to identify the first terminal device or associated user and/or to indicate that subsequent messages (e.g., transmitted in association with an identifier of the channel, associated with a particular client, etc.) are to be routed to or to have routing inclined towards the first terminal device.

Conversely, connection system 150 may determine that the characteristic indicates that subsequent messages from network device 105 (e.g., relating to a client) are not to be routed to the same first terminal device and/or are to be rerouted. For example, it can be determined that the condition in the continuous-channel rule is not satisfied. Upon such a determination, connection system 150 can identify a new terminal device to route communications (e.g., relating to a client) to from the network device.

In one instance, a continuous-channel rule is configured such that a continuous channel is to be established between a network device and a terminal device following an initial routing of a communication between the two devices. Thus, the continuous channel may serve to facilitate consistent message routing within a single conversation (e.g., series of communicated messages). In an alternative or same instance, a continuous-channel rule may (also or alternatively) be configured such that a continuous channel is established, maintained or used so as to execute consistent message routing across different message series (e.g., the series being separated in time). Depending on the embodiment, a continuous-channel rule may limit a number of continuous channels that can be provided with respect to a network device and/or client. For example, a rule may indicate that, for a network device and client, the network device can only be connected to one (or three or another specified number) terminal devices via continuous channel.

In some instances, connection system 150 can determine that a re-routing process is to be initiated (e.g., based on satisfaction of a condition in a re-routing rule). The determination can be based on a characteristic (e.g., characterizing message content, including a statistic or characterizing an input). For example, a re-routing rule can be configured such that re-routing is to be initiated upon detecting a characteristic indicative of user frustration or dissatisfaction; detecting a characteristic indicative of a lack of progress towards a resolution of an issue; detecting impermissible terminal-device communication statistics (e.g., long response latencies); or detecting that messages are beginning to focus on a new topic.

A re-routing process can include identifying a different terminal device to participate in a communication session with network device 105. Such an identification can be based on, for example, a topic associated with the communication, a polarity parameter associated with the communication or a past related communication, an estimated response latency for terminal device 115, a type of communication channel associated with the communication (e.g., instant message, message, email, phone), a type of each of one or more other terminal devices, a capability of one or more other terminal devices, and the like. A selection of the different terminal device may be performed in a same, similar or different manner as compared to a selection of a first terminal device. For example, determining that a re-routing rule's condition has been satisfied may incline a subsequent terminal-device selection towards higher-ordering devices.

A re-routing process may include transmitting a notification identifying a proposed re-routing to one or more devices, such as network device 105, the first terminal device or the different terminal device. The notification may include an option to authorize and/or an option reject the proposed re-routing. The notification may include data about network device 105, the first terminal device and/or the different terminal device and/or an associated party.

To reduce an abrupt transition between terminal devices, connection system 150 can coordinate an overlap time period. During this time period, each of the first terminal device and the different terminal device can receive one or more communications (or processed versions thereof) from network device 105. For example, a new communication from network device 105 can be duplicated and then routed to each of the first and different terminal device.

In some instances, connection system 150 can generate a dynamic message chronicle that includes multiple messages from network device 105 and/or from the first terminal device. The chronicle can include, for example, all messages in a communication session, all messages routed within a defined time period (e.g., previous 3 minutes), or all messages associated with one or more defined tags or types. For example, messages relating to a particular topic, message polarity (e.g., corresponding to dissatisfaction), or content type (e.g., including a question) can be selected. Connection system 150 can transmit the dynamic message chronicle to the different terminal device. New messages from network device 105 and/or the first terminal device can further be transmitted to the different terminal device, such that the dynamic message chronicle can be appended with such new messages. Message selection for a dynamic message chronicle and/or whether a dynamic message chronicle is to be provided may also depend on whether re-routing is to occur during a temporally clustered series of messages or between message series.

In some instances, connection system 150 can determine whether and/or when to stop routing communications to the first terminal device. For example, such routing termination may be performed upon detecting a response communication from the different terminal device, after a defined time period has elapsed following transmission of the message chronicle, after detecting an input received at the first terminal device indicating an intent to terminate a communication session, after detecting an input received at the different terminal device indicating an intent to handle a communication session, after detecting an input received at network device 105 requesting the proposed re-routing to the different terminal device be executed, and so on.

Depending on a rule or a reason for initiating a re-routing transfer, the re-routing may include closing a connection channel between network device 105 and the first terminal device (e.g., if a re-routing process was initiated in response to a low user polarity) and/or establishing a new connection channel between network device 105 and the different terminal device.

Each communication (e.g., between devices, between a device and connection system 150, between remote server 140 and connection system 150 or between remote server 140 and a device) can occur over one or more networks 170. Any combination of open or closed networks can be included in the one or more networks 170. Examples of suitable networks include the Internet, a personal area network, a local area network (LAN), a wide area network (WAN), or a wireless local area network (WLAN). Other networks may be suitable as well. The one or more networks 170 can be incorporated entirely within or can include an intranet, an extranet, or a combination thereof. In some instances, a network in the one or more networks 170 includes a short-range communication channel, such as a Bluetooth or a Bluetooth Low Energy channel. In one embodiment, communications between two or more systems and/or devices can be achieved by a secure communications protocol, such as secure sockets layer (SSL) or transport layer security (TLS). In addition, data may be encrypted based on any convenient, known, or to be developed manner, such as, but not limited to, Data Encryption Standard (DES), Triple DES, Rivest-Shamir-Adleman encryption (RSA), Blowfish encryption, Advanced Encryption Standard (AES), CAST-128, CAST-256, Decorrelated Fast Cipher (DFC), Tiny Encryption Algorithm (TEA), eXtended TEA (XTEA), Corrected Block TEA (XXTEA), and/or RC5, etc.

A network device 105, terminal device 115 and/or client device 130 can include, for example, a portable electronic device (e.g., a smart phone, tablet, laptop computer, or smart wearable device) or a non-portable electronic device (e.g., one or more desktop computers, smart appliances, servers, and/or processors). Connection system 150 can be separately housed from network, terminal and client devices or may be part of one or more such devices (e.g., via installation of an application on a device). Remote server 140 may be separately housed from each device and connection system 150 and/or may be part of another device or system. While each device, server and system in FIG. 1 is shown as a single device, it will be appreciated that multiple devices may instead be used. For example, a set of network devices can be used to transmit various communications from a single user, or remote server 140 may include a server stack.

A software agent or application may be installed on and/or executable on a depicted device, system or server. In one instance, the software agent or application is configured such that various depicted elements can act in related manners. For example, a software agent on a device can be configured to obtain and transmit data about device usage to a separate connection system, and a software application on the separate connection system can be configured to receive and process the data.

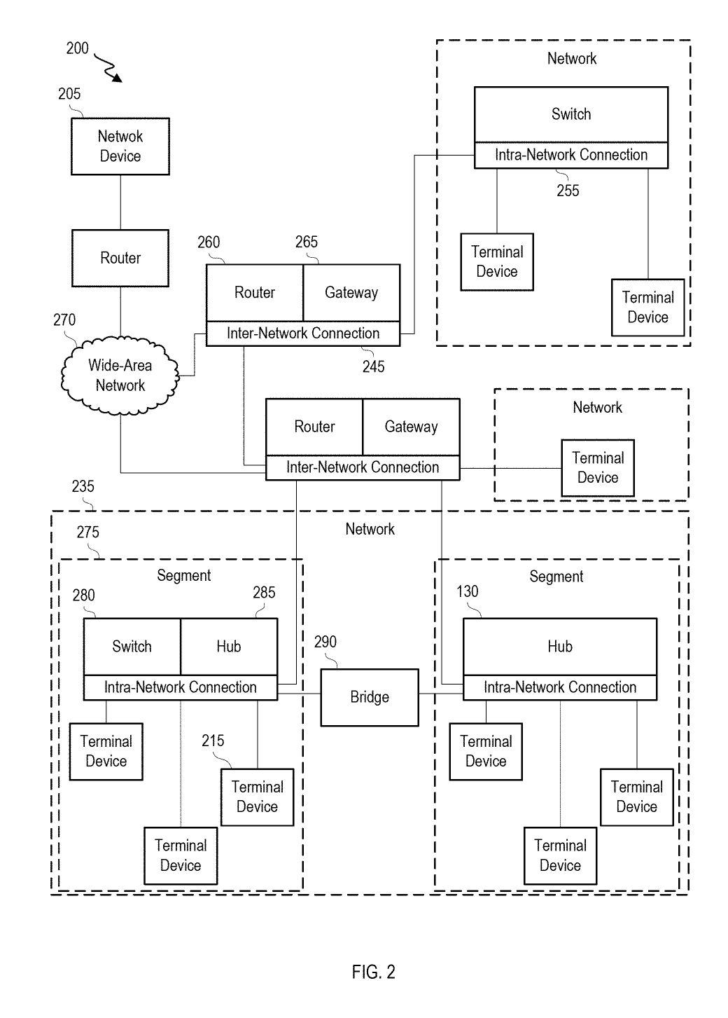

FIG. 2 shows a block diagram of another embodiment of a network interaction system 200. Generally, FIG. 2 illustrates a range of components configured and arranged to enable a network device 205 to communicate with one or more terminal devices 215. The depicted instance includes nine terminal devices 215 included in three local-area networks 235.

In some instances, a communication from network device 205 includes destination data (e.g., a destination IP address) that at least partly or entirely indicates which terminal device is to receive the communication. Network interaction system 200 can include one or more inter-network connection components 240 and/or one or more intra-network connection components 255 that can process the destination data and facilitate appropriate routing.

Each inter-network connection components 245 can be connected to a plurality of networks 235 and can have multiple network cards installed (e.g., each card connected to a different network). For example, an inter-network connection component 245 can be connected to a wide-area network 270 and one or more local-area networks 235. In the depicted instance, in order for a communication to be transmitted from network device 205 to any of the terminal devices, in the depicted system, the communication must be handled by multiple inter-network connection components 245.

When an inter-network connection component 245 receives a communication (or a set of packets corresponding to the communication), inter-network connection component 245 can determine at least part of a route to pass the communication to a network associated with a destination. The route can be determined using, for example, a routing table (e.g., stored at the router), which can include one or more routes that are pre-defined, generated based on an incoming message (e.g., from another router or from another device) or learned.

Examples of inter-network connection components 245 include a router 260 and a gateway 265. An inter-network connection component 245 (e.g., gateway 265) may be configured to convert between network systems or protocols. For example, gateway 265 may facilitate communication between Transmission Control Protocol/Internet Protocol (TCP/IP) and Internetwork Packet Exchange/Sequenced Packet Exchange (IPX/SPX) devices.

Upon receiving a communication at a local-area network 235, further routing may still need to be performed. Such intra-network routing can be performed via an intra-network connection component 255, such as a switch 280 or hub 285. Each intra-network connection component 255 can be connected to (e.g., wirelessly or wired, such as via an Ethernet cable) multiple terminal devices 215. Hub 285 can be configured to repeat all received communications to each device to which it is connected. Each terminal device can then evaluate each communication to determine whether the terminal device is the destination device or whether the communication is to be ignored. Switch 280 can be configured to selectively direct communications to only the destination terminal device.

In some instances, a local-area network 235 can be divided into multiple segments, each of which can be associated with independent firewalls, security rules and network protocols. An intra-network connection component 255 can be provided in each of one, more or all segments to facilitate intra-segment routing. A bridge 280 can be configured to route communications across segments 275.

To appropriately route communications across or within networks, various components analyze destination data in the communications. For example, such data can indicate which network a communication is to be routed to, which device within a network a communication is to be routed to or which communications a terminal device is to process (as opposed to ignore). However, in some instances, it is not immediately apparent which terminal device (or even which network) is to participate in a communication from a network device.

To illustrate, a set of terminal devices may be configured so as to provide similar types of responsive communications. Thus, it may be expected that a query in a communication from a network device may be responded to in similar manners regardless to which network device the communication is routed. While this assumption may be true at a high level, various details relating to terminal devices can give rise to particular routings being advantageous as compared to others. For example, terminal devices in the set may differ from each other with respect to (for example) which communication channels are supported, location and/or network proximity to a network device and/or characteristics of associated agents (e.g., availability, etc.). Accordingly, select routings may facilitate faster responses that more accurately and/or completely respond to a network-device communication. A complication is that static routings mapping network devices to terminal devices may fail to consider variations in communication topics, channel types, agent availability, and so on.

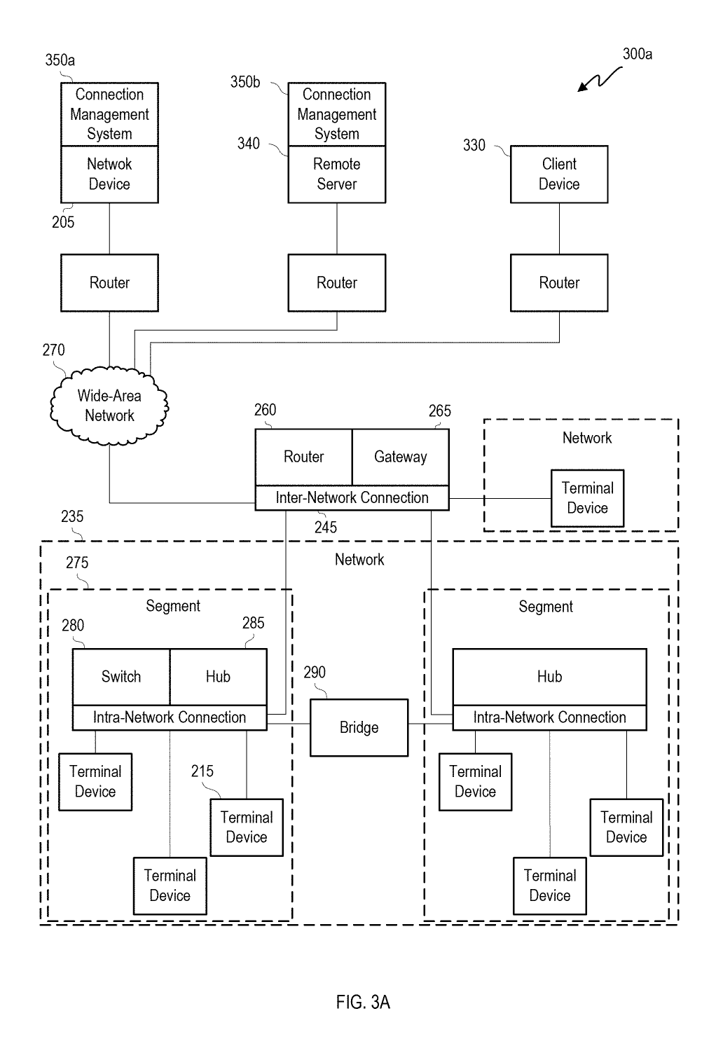

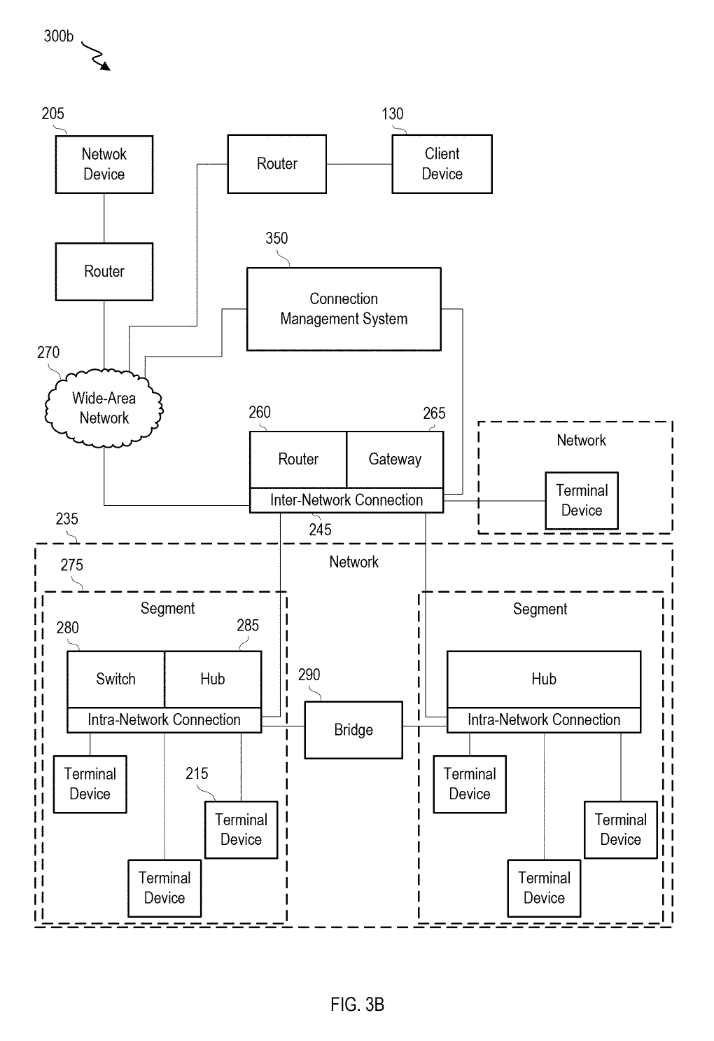

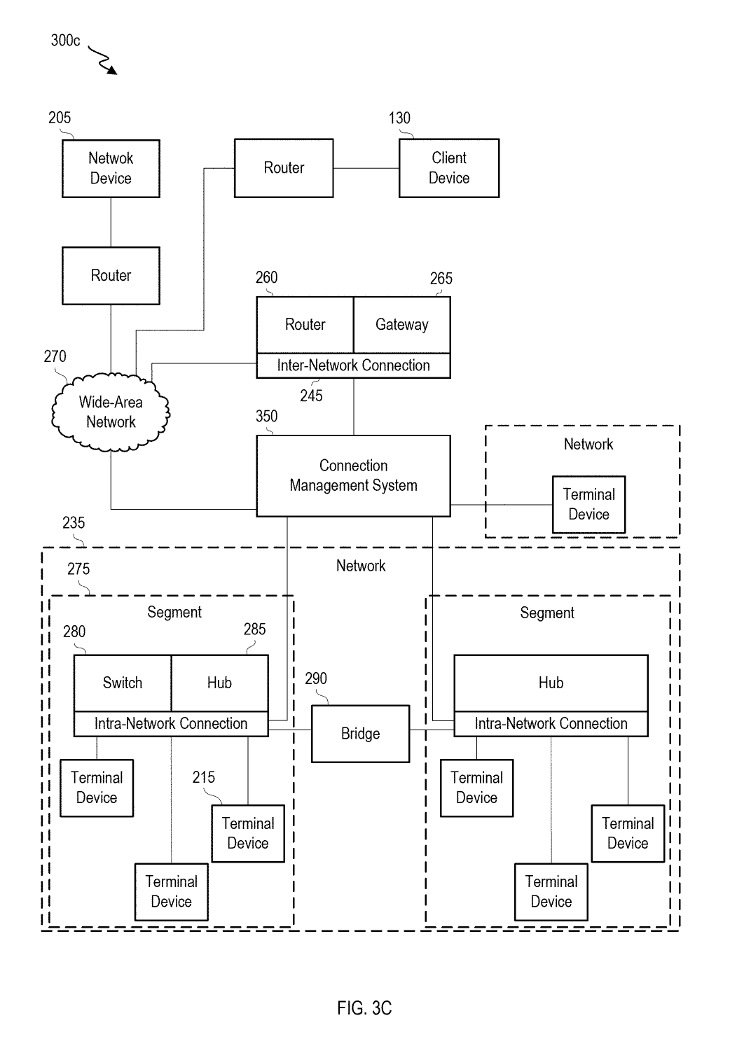

FIGS. 3A-3C show block diagrams of other embodiments of a network interaction system 300a-c that includes a connection system. Each of the depicted systems 300a-c show only 2 local-area networks 235 for simplicity, though it can be appreciated that embodiments can be extended to expand the number of local-area networks. Each of systems 300a-c include a connection system 350, which can identify which terminal device is to communicate with network device 205, can establish and manage (e.g., maintain or close) connection channels, can determine whether and when to re-route communications in an communication session, and so on. Thus, connection system 350 can be configured to dynamically, and in real-time, evaluate communications, agent availability, capabilities of terminal devices or agents, and so on, to influence routing determinations.

In FIG. 3A, connection system 350 is associated with each of network device 205 and a remote server 340 (e.g., connection system 350a is associated with network device 205 and connection system 350b is associated with remote server 340). For example, connection system 350a and/or connection system 350b can be installed or stored as an application on each of network device 205 and remote server 340, respectively. Execution of the application(s) can facilitate, for example, a communication between network device 205 and remote server 340 to identify a terminal device 215 selected to participate in a communication session with network device 205. The identification can be made based on one or more factors disclosed herein (e.g., availability, connections between a communication's topic/level of detail with agents' or terminal devices' resource sets, estimated latency, channel-type availability, and so on).

A client device 330 can provide client data indicating how routing determinations are to be made. For example, such data can include: indications as to how particular characteristics are to be weighted or constraints or inclinations (e.g., relating to load balancing or estimated response latency). Client data can also include specifications related to when communication channels are to be established (or closed) or when communications are to be re-routed to a different network device. Client data can be used to define various client-specific rules, such as rules for communication routing; channel establishment, or closing; communication re-routing; communication type-identification, and so on.

Connection system 350b executing on remote server 340 can monitor various metrics relating to terminal devices (e.g., relating to a client), such as which communication channels are supported, location and/or network proximity to a network device, communication latency and/or stability with the terminal device, a type of the terminal device, a capability of the terminal device, whether the terminal device (or agent) has communicated with a network device (or user) before and/or characteristics of associated agents (e.g., languages spoken, availability, etc.). Accordingly, communication system 350b may be enabled to select routings to facilitate faster responses that more accurately and/or completely respond to a network-device communication based on the metrics.

In the example depicted in FIG. 3A, a communication session between network device 205 and remote server 340 can facilitate early identification of a destination address. Network device 205 may then use the destination address to direct subsequent communications. For example, network device 205 may send an initial communication to remote server 340 (e.g., via one or more inter-network connections and a wide-area network), and remote server 340 may identify one or more corresponding clients. Remote server 340 may then identify a set of terminal devices associated with the one or more corresponding clients and obtain metrics for those terminal devices. The metrics can be evaluated (e.g., by remote server 340) so as to select a terminal device to involve in a communication session, and data relating to the terminal device (e.g., an IP address) can be sent to network device 205. In some embodiments, remote server 340 may continuously or periodically obtain and evaluate metrics for various terminal devices and store evaluation results in a data store. In such embodiments, upon identifying a set of terminal devices associated with the one or more corresponding clients, remote server 340 can access the stored evaluation results from the data store and select a terminal device to involve in the communication session based on the stored evaluation results.

In FIG. 3B, connection system 350 can be configured to serve as a relay and/or destination address. Thus, for example, a set of network devices 205 may transmit communications, each identifying connection system 350 as a destination. Connection system 350 can receive each communication and can concurrently monitor a set of terminal devices (e.g., so as to generate metrics for each terminal device). Based on the monitoring and a rule, connection system 350 can identify a terminal device 215 to which it may relay each communication. Depending on the embodiment, terminal device communications may similarly be directed to a consistent destination (e.g., of connection system 350) for further relaying, or terminal devices may begin communicating directly with corresponding network devices. These embodiments can facilitate efficient routing and thorough communication monitoring.

The embodiment depicted in FIG. 3C is similar to that in FIG. 3B. However, in some embodiments, connection system 350 is directly connected to intra-network components (e.g., terminal devices, intra-network connections, or other).

It will be appreciated that many variations of FIGS. 3A-3C are contemplated. For example, connection system 350 may be associated with a connection component (e.g., inter-network connection component 245 or intra-network connection component 255) such that an application corresponding to connection system 350 (or part thereof) is installed on the component. The application may, for example, perform independently or by communicating with one or more similar or related applications (e.g., executing on one or more other components, network devices or remotes servers).

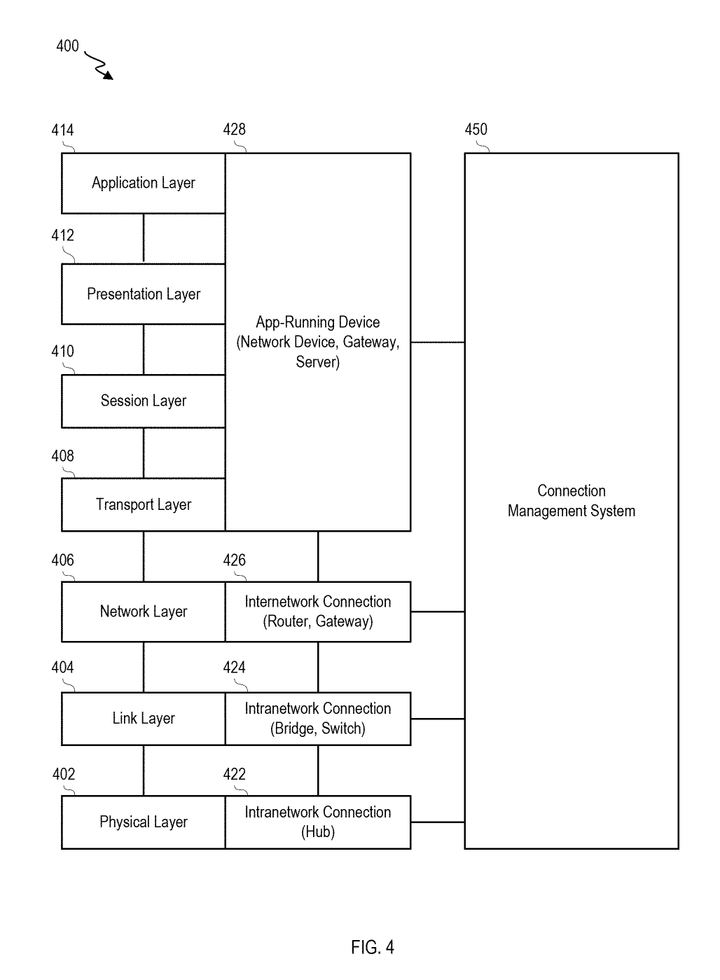

FIG. 4 shows a representation of a protocol-stack mapping 400 of connection components' operation. More specifically, FIG. 4 identifies a layer of operation in an Open Systems Interaction (OSI) model that corresponds to various connection components.

The OSI model can include multiple logical layers 402-414. The layers are arranged in an ordered stack, such that layers 402-412 each serve a higher level and layers 404-414 is each served by a lower layer. The OSI model includes a physical layer 402. Physical layer 402 can define parameters physical communication (e.g., electrical, optical, or electromagnetic). Physical layer 402 also defines connection protocols, such as protocols to establish and close connections. Physical layer 402 can further define a flow-control protocol and a transmission mode.

A link layer 404 can manage node-to-node communications. Link layer 404 can detect and correct errors (e.g., transmission errors in the physical layer 402) and manage access permissions. Link layer 404 can include a media access control (MAC) layer and logical link control (LLC) layer.

A network layer 406 can coordinate transferring data (e.g., of variable length) across nodes in a same network (e.g., as datagrams). Network layer 406 can transform a logical network address to a physical machine address.

A transport layer 408 can manage transmission and receipt quality. Transport layer 408 can provide a protocol for transferring data, such as a Transmission Control Protocol (TCP). Transport layer 408 can perform segmentation/desegmentation of data packets for transmission and can detect transmission errors occurring in layers 402-406. A session layer 410 can initiate, maintain and terminate connections between local and remote applications. Sessions may be used as part of remote-procedure interactions. A presentation layer 412 can encrypt, decrypt and format data based on data types known to be accepted by an application or network layer.

An application layer 414 can interact with software applications that control or manage communications. Via such applications, application layer 414 can (for example) identify destinations, local resource states or availability and/or communication content or formatting. Various layers 402-414 can perform other functions as available and applicable.

Intra-network connection components 422, 424 are shown to operate in physical layer 402 and link layer 404. More specifically, a hub can operate in the physical layer, such that operations can be controlled with respect to receipts and transmissions of communications. Because hubs lack the ability to address communications or filter data, they possess little to no capability to operate in higher levels. Switches, meanwhile, can operate in link layer 404, as they are capable of filtering communication frames based on addresses (e.g., MAC addresses).

Meanwhile, inter-network connection components 426, 428 are shown to operate on higher levels (e.g., layers 406-414). For example, routers can filter communication data packets based on addresses (e.g., IP addresses). Routers can forward packets to particular ports based on the address, so as to direct the packets to an appropriate network. Gateways can operate at the network layer and above, perform similar filtering and directing and further translation of data (e.g., across protocols or architectures).

A connection system 450 can interact with and/or operate on, in various embodiments, one, more, all or any of the various layers. For example, connection system 450 can interact with a hub so as to dynamically adjust which terminal devices the hub communicates. As another example, connection system 450 can communicate with a bridge, switch, router or gateway so as to influence which terminal device the component selects as a destination (e.g., MAC, logical or physical) address. By way of further examples, a connection system 450 can monitor, control, or direct segmentation of data packets on transport layer 408, session duration on session layer 410, and/or encryption and/or compression on presentation layer 412. In some embodiments, connection system 450 can interact with various layers by exchanging communications with (e.g., sending commands to) equipment operating on a particular layer (e.g., a switch operating on link layer 404), by routing or modifying existing communications (e.g., between a network device and a terminal device) in a particular manner, and/or by generating new communications containing particular data (e.g., new destination addresses) based on the existing communication. Thus, connection system 450 can influence communication routing and channel establishment (or maintenance or termination) via interaction with a wide range of devices and/or via influencing operating at a wide range of protocol-stack layers.

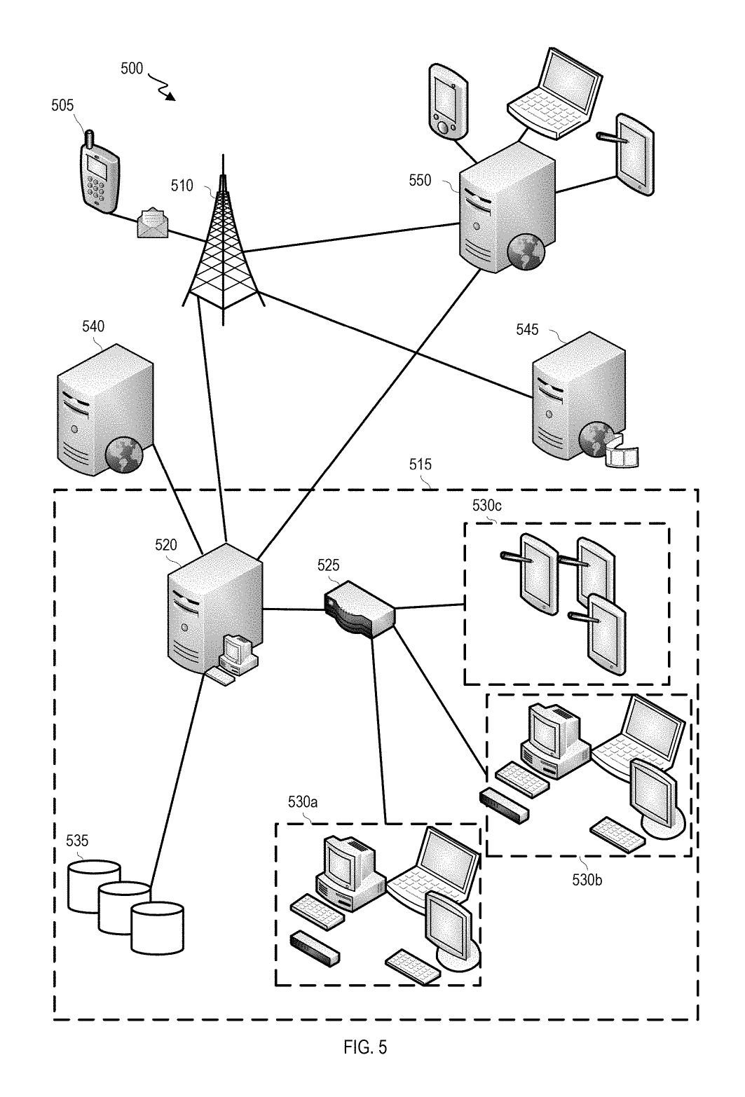

FIG. 5 represents a multi-device communication interaction system 500 according to an embodiment. System 500 includes a network device 505 configured to communicate with a various terminal devices over various types of communication channels.

In the depicted instance, network device 505 can transmit a communication over a cellular network (e.g., via a base station 510). The communication can be routed to an operative network 515. Operative network 515 can include a connection system 520 that receives the communication and identifies which terminal device is to respond to the communication. Such determination can depend on identifying a client to which that communication pertains (e.g., based on a content analysis or user input indicative of the client) and determining one or more metrics for each of one or more terminal devices associated with the client. For example, in FIG. 5, each cluster of terminal devices 530a-c can correspond to a different client. The terminal devices may be locationally co-located or disperse. The metrics may be determined based on stored or learned data and/or real-time monitoring (e.g., based on availability).

Connection system 520 can communicate with various terminal devices via one or more routers 525 or other inter-network or intra-network connection components. Connection system 520 may obtain, analyze and/or store data from or relating to communications, terminal-device operations, client rules, and/or user-associated actions (e.g., interaction activity on a network site, etc.) at one or more data stores. Such data may influence communication routing.

Notably, various other devices can further be used to influence communication routing and/or processing. For example, in the depicted instance, connection system 520 also is connected to a network server 540. Thus, connection system 540 can retrieve data of interest, such as technical object details and additional data, and so on.

Network device 505 may also be connected to a network server (e.g., including a streaming network server 545). In some instances, communication with such a server provided an initial option to initiate a communication session with connection system 520. For example, network device 505 may detect that, while visiting a particular network site, a communication option is available and such an option can be presented.

One or more elements of communication system 500 can also be connected to a social-networking server 550. Social networking server 550 can aggregate data received from various user devices. Thus, for example, connection system 520 may be able to estimate a general (or user-specific) polarity towards a particular topic or estimate a general action of a user or type of users.

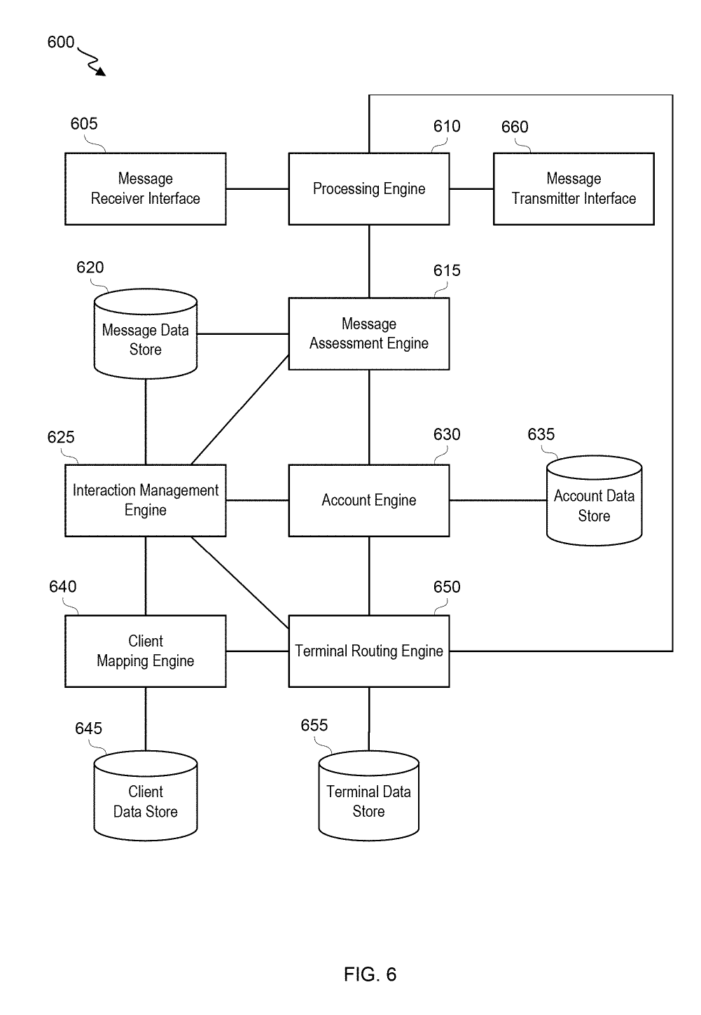

FIG. 6 shows a block diagram of an embodiment of a connection system 600. A message receiver interface 605 can receive a message. In some instances, the message can be received, for example, as part of a communication transmitted by a source device (e.g., housed separately from connection system 600 or within a same housing), such as a network device or terminal device. In some instances, the communication can be part of a series of communications or a communicate session, which can include a series of messages or message being routed between two devices (e.g., a network device and terminal device). This message or communication session may be part of and/or may define an interaction between the devices. A communication channel or operative channel can include one or more protocols (e.g., routing protocols, task-assigning protocols and/or addressing protocols) used to facilitate routing and a communication session between the devices.

In some instances, the message can include a message generated based on inputs received at a local or remote user interface. For example, the message can include a message that was generated based on button or key presses or recorded speech signals. In one instance, the message includes an automatically generated message, such as one generated upon detecting that a network device is presenting a particular app page or network interface or has provided a particular input command (e.g., key sequence). The message can include an instruction or request, such as one to initiate a communication session.

In some instances, the message can include or be associated with an identifier of a client. For example, the message can explicitly identify the client (or a device associated with the client); the message can include or be associated with a network interface or app page associated with the client; the message can include or be associated with a destination address associated with a client; or the message can include or be associated with an identification of an object associated with the client. To illustrate, a network device may be presenting an app page of a particular client, which may provide an option to transmit a communication to an agent. Upon receiving user input corresponding to a message, a communication may be generated to include the message and an identifier of the particular client.

A processing unit 610 may process a received communication and/or message. Processing can include, for example, extracting one or more particular data elements (e.g., a message, a client identifier, a network-device identifier, a user or user protocol identifier, and so on). Processing can include transforming a formatting or communication type (e.g., to be compatible with a particular device type, operating system, communication-channel type, protocol and/or network).

A message determination unit 615 may determine the message. The determination can include identifying, for example, one or more types or tags for the message. Examples of type or tag types can include (for example) topic, message polarity, complexity, and urgency. A difference between determining a type of message and tagging a message can be that types can be limited (e.g., according to a predefined set of type options), while tags can be open. A topic can include, for example, an object, a technical issue, a use question, a complaint, or other suitable topic. A type or tag can be determined, for example, based on a semantic analysis of a message (e.g., by identifying keywords, sentence structures, repeated words, punctuation characters and/or non-article words); user input (e.g., having selected one or more types); and/or message-associated statistics (e.g., typing speed and/or response latency).

In some instances, message determination unit 615 can determine a metric for a message. A metric can include, for example, a number of characters, words, capital letters, all-capital words or instances of particular characters or punctuation marks (e.g., exclamation points, question marks and/or periods). A metric can include a ratio, such as a fraction of sentences that end with an exclamation point (or question mark), a fraction of words that are all capitalized, and so on.

Message determination unit 615 can store a message, message metric and/or message statistic in a message data store 620. Each message can also be stored in association with other data (e.g., metadata), such as data identifying a corresponding source device, destination device, network device, terminal device, client, one or more types, one or more stages and/or message-associated statistics). Various components of connection system 600 (e.g., message determination unit 615 and/or an interaction unit 625) can query message data store 620 to retrieve query-responsive messages, message metrics and/or message statistics.

An interaction unit 625 can determine to which device a communication is to be routed and how the receiving and transmitting devices are to communicate. Each of these determinations can depend, for example, on whether a particular network device (or any network device associated with a particular user) has previously communicated with a terminal device in a set of terminal devices (e.g., any terminal device associated with connection system 600 or any terminal device associated with one or more particular clients).

In some instances, when a network device (or other network device associated with a sane user or user protocol (e.g., profile)) has previously communicated with a terminal device (e.g., about matters relating to a client), communication routing can be generally inclined towards the same terminal device. Other factors that may influence routing can include, for example, an inferred or identified user or agent polarity relating to the previous communication; a topic of a present communication (e.g., and an extent to which that relates to a topic of a previous communication and/or a resource set associated with one or more terminal devices or agents); whether the terminal device (or corresponding agent) is available; and/or an estimated response latency of the terminal device. Such factors may be considered absolutely or relative to similar metrics corresponding to other terminal devices. A re-routing rule (e.g., a client-specific or general rule) can indicate how such factors are to be evaluated and weighted to determine whether to forego agent consistency.

When a network device (or other network device associated with a same user or user protocol) has not previously communicated with a terminal device (e.g., about matters relating to a client), a terminal-device selection can be performed based on factors such as, for example, an extent to which various agents' resource set corresponds to a communication topic, availability of various agents at a time and/or over a channel type, types and/or capabilities of terminal devices (e.g., associated with the client), a language similarity between a user and agents. In one instance, a rule can identify how to determine a sub-parameter to one or more factors such as these and a weight to assign to each parameter. By combining (e.g., summing) weighted sub-parameters, a parameter for each agent can be determined. A terminal device selection can then be made by comparing terminal devices' parameters (e.g., to select a high or highest value).

With regard to determining how devices are to communicate, interaction unit 625 can (for example) determine whether a terminal device is to respond to a communication via (for example) email, chat, SMS message, voice call, video chat, etc. A communication type can be selected based on, for example, a communication-type priority list (e.g., at least partly defined by a client or user); a type of a communication previously received from the network device, a complexity of a received message, capabilities of the network device, and/or an availability of one or more terminal devices. Appreciably, some communication types will result in real-time communication (e.g., where fast message response is expected), while others can result in asynchronous communication (e.g., where delays (e.g., of several minutes or hours) between messages are acceptable).

Further, interaction unit 625 can determine whether a continuous channel between two devices should be established, used or terminated. A continuous channel can be structured so as to facilitate routing of communications from a network device to a specified terminal device. This inclination can persist even across message series (e.g., days, weeks or months). In some instances, a representation of a continuous channel (e.g., identifying an agent) can be included in a presentation to be presented on a network device. In this manner, a user can understand that communications are to be consistently routed.

In one instance, a parameter (e.g., a score or value, etc.) can be generated using one or more factors described herein and a rule (e.g., that includes a weight for each of the one or more factors) to determine a connection parameter corresponding to a network device and terminal device. The parameter may relate to an overall similarity or one specific to a communication or communication series. Thus, for example, the parameter may reflect a degree to which a terminal device is estimated to be suited to respond to a network-device communication. In some instances, analysis of the parameter can identify a terminal device to route a communication to and whether to establish, use or terminate a connection channel. When an analysis is used to both address a routing decision and a channel decision, a parameter relevant to each decision may be determined in a same, similar or different manner.

Thus, for example, it will be appreciated that different factors may be considered depending on whether the parameter is to estimate a strength of a long-term similarity compared to one to respond to a particular message query. For example, in the former instance, considerations of overall schedules and time zones may be important, while in the latter instance, immediate availability may be more highly weighted. A parameter can be determined for a single network-device/terminal-device combination, or multiple parameters can be determined, each characterizing a similarity between a network device and a different terminal device.

To illustrate, a set of three terminal devices associated with a client may be evaluated for determining candidate terminal devices for communication routing. A parameter may be generated for each that relates to a similarity for the particular communication. Each of the first two terminal devices may have previously communicated with a network device having transmitted the communication. An input from the network device may have indicated satisfaction with an interaction with the communication(s) with the first device. Thus, a past-interact sub-parameter (as calculated according to a rule) for the first, second and third devices may be 10, 5, and 0, respectively. (Negative satisfaction inputs may result in negative sub-parameters.) It may be determined that only the third terminal device is immediately available. It may be estimated that the second terminal device will be available for responding within 15 minutes, but that the first terminal device will not be available for responding until the next day. Thus, a fast-response sub-parameter for the first, second and third devices may be 1, 3 and 10. Finally, it may be estimated a degree to which an agent (associated with the terminal device) can communicate regarding a topic. It may be determined that an agent associated with the third terminal device can communicate with a network device at a higher level than those associated with the other two devices, resulting in sub-parameters of 3, 4 and 9. In this example, the rule does not include weighting or normalization parameters (though, in other instances, a rule may), resulting in parameters of 14, 11 and 19. Thus, the rule may indicate that the message is to be routed to a device with the highest parameter, that being the third terminal device. If routing to a particular terminal device is unsuccessful, the message can be routed to a device with the next-highest parameter, and so on.

A parameter may be compared to one or more absolute or relative thresholds. For example, parameters for a set of terminal devices can be compared to each other to identify a high parameter to select a terminal device to which a communication can be routed. As another example, a parameter (e.g., a high parameter) can be compared to one or more absolute thresholds to determine whether to establish a continuous channel with a terminal device. An overall threshold for establishing a continuous channel may (but need not) be higher than a threshold for consistently routing communications in a series of messages. This difference between the overall threshold and threshold for determining whether to consistently route communication may be because a strong similarity is important in the continuous-channel context considering the extended utility of the channel. In some embodiments, an overall threshold for using a continuous channel may (but need not) be lower than a threshold for establishing a continuous channel and/or for consistently routing communications in a series of messages.

Interaction unit 625 can interact with an user data unit 630 in various contexts. For example, user data unit 630 may look up an identifier of a network device or terminal device in a protocol data store 635 to identify a protocol corresponding to the device. Further, user data unit 630 can maintain data about previous communication sessions (e.g., times, involved other device(s), channel type, resolution stage, topic(s) and/or associated client identifier), connection channels (e.g., indicating—for each of one or more clients—whether any channels exist, a terminal device associated with each channel, an establishment time, a usage frequency, a time of last use, any channel constraints and/or supported types of communication), user or agent preferences or constraints (e.g., related to terminal-device selection, response latency, terminal-device consistency, agent resource set, and/or communication-type preference or constraint), and/or user or agent characteristics (e.g., age, language(s) spoken, location, interests, and so on).

Further, interaction unit 625 can alert user data unit 630 of various connection-channel actions, such that protocol data store 635 can be updated to reflect the current channel data. For example, upon establishing a channel, interaction unit 625 can notify user data unit 630 of the establishment and identify one or more of: a network device, a terminal device, a user protocol and a client. protocol unit 635 can (in some instances) subsequently notify a user of the channel's existence such that the user can be aware of the agent consistency being availed.

Interaction unit 625 can further interact with a client mapping unit 640, which can map a communication to one or more clients (and/or associated brands). In some instances, a communication received from a network device itself includes an identifier corresponding to a client (e.g., an identifier of a client, object provided by a client, network site, or app page). The identifier can be included as part of a message (e.g., which client mapping unit 640 may detect) or included as other data in a message-inclusive communication. Client mapping unit 640 may then look up the identifier in a client data store 645 to retrieve additional data about the client and/or an identifier of the client.

In some instances, a message may not particularly correspond to any client. For example, a message may include a general query. Client mapping unit 640 may, for example, perform a semantic analysis on the message, identify one or more keywords and identify one or more clients associated with the keyword(s). In some instances, a single client is identified. In some instances, multiple clients are identified. An identification of each client may then be presented via a network device such that a user can select a client to communicate with (e.g., via an associated terminal device).

Client data store 645 can include identifications of one or more terminal devices (and/or agents) associated with the client. A terminal routing unit 650 can retrieve data relating to each of one, more or all such terminal devices (and/or agents) so as to influence routing determinations. For example, terminal routing unit 650 may maintain a terminal data store 655, which can store data such as terminal devices' device types, operating system, communication-type capabilities, installed applications accessories, location and/or identifiers (e.g., IP addresses). Data can also include agent data, such as position, resource sets (e.g., topics that the agent is knowledgeable about), identifier metrics, working hours, language(s) spoken and/or location data. Some data can be dynamically updated. For example, data indicating whether a terminal device is available may be dynamically updated based on (for example) a communication from a terminal device (e.g., identifying whether the device is asleep, being turned off/on, idle/active, or identifying whether input has been received within a time period); a communication routing (e.g., indicative of whether a terminal device is involved in or being assigned to be part of a communication session); or a communication from a network device or terminal device indicating that a communication session has ended or begun.

It will be appreciated that, in various contexts, being included in one or more communication sessions do not necessarily indicate that a terminal device is not available to communicate in another communication session. Various factors, such as communication types (e.g., message, email, communication, phone), client-identified or user-identified target response times, and/or system loads (e.g., generally or with respect to a user) may influence how many communication sessions a terminal device may be involved in.

When interaction unit 625 has identified a terminal device to involve in a communication session or connection channel, it can notify terminal routing unit 650, which may retrieve any pertinent data about the terminal device from terminal data store 655, such as a destination (e.g., IP) address, device type, protocol, etc. Processing unit 610 can then (in some instances) modify the message-inclusive communication or generate a new communication (including the message) so as to have a particular format, comply with a particular protocol, and so on. In some instances, a new or modified message may include additional data, such as user data corresponding to a network device, a message chronicle, and/or client data.

A message transmitter interface 660 can then transmit the communication to the terminal device. The transmission may include, for example, a wired or wireless transmission to a device housed in a separate housing. The terminal device can include a terminal device in a same or different network (e.g., local-area network) as connection system 600. Accordingly, transmitting the communication to the terminal device can include transmitting the communication to an inter- or intra-network connection component.

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

The methods, techniques and systems presented herein may involve using one or more computational platforms with capabilities for data storage, computation and electronic network communications. The term “computational platform”, “terminal” or “device” shall be understood as referring to any type of computational apparatus or network of apparatuses. For example, a computational platform may be a network server, and this disclosure will hereinafter use the term “communication server” to refer to such a computational apparatus which is configured to perform certain of the functions which will be described hereinafter.

The disclosure of communication server methods and functionality presented herein is applicable to servers in any of the configurations which will be recognizable or foreseeable to a person of ordinary skill in the many arts to which this document is pertinent. As an example only, an communication server within the scope of this disclosure may be connected to other servers and user communication terminals through an internet, mobile, satellite, wireless or other network connection.

This disclosure describes the use of a communication server to interface with network devices of social-networks and use social network access in performing data accumulation, conduct tracking, prediction, selection and machine-learning tasks for clients seeking to generate, implement and/or dynamically alter one or more targeted operations which involve electronic or network communications. A communication server may be applied to any type of operation involving communications. For example, the techniques presented herein may be applicable by a communication server for the purpose of advancing a communications program for any activity which may be enhanced, as will be described herein.

Hereinafter, a client will refer to any party which is provided with functionality facilitated by an communication server which implements techniques of this disclosure. The communication server may be used for the purposes of estimating the results of alternatively-selectable candidate interaction protocols for executing a client's communication program. An interaction protocol may be understood as one or more possible ways in which network-based communications may be customized or performed. An example of a simple candidate interaction protocol could involve displaying specific content data on a chosen interface (e.g., a fan page on FACEBOOK) of specific users of a social-network.

Other interaction protocols could incorporate specific user data obtained using techniques which will be described subsequently. An example of one such interaction protocol could include displaying certain content only to a subset of users who have satisfied a certain condition. For example, one such condition could target the content so that only users of a certain age and living in a certain location receive the content. An attribute (e.g., characteristic, such as location) of a user may be evaluated to determine whether the attribute satisfies the condition that corresponds to the interaction protocol.

An interaction protocol may take other forms as well. Interaction protocols may be defined to be specific to individual users and/or groups of users. For example, an interaction protocol may specify communication methods particularly chosen to be used to communicate with a specific user, the message content to transmit to the user, the frequency of attempts to communicate with the user, or the information to be solicited from the user. An interaction protocol with respect to an individual user may involve avoiding communications with the user, or discontinuing data gathering, analysis, or monitoring of the user. An interaction protocol to avoid a user, or avoid gathering a user's data may be effective in dealing with a user who holds a negative opinion of the client and is unlikely to ever view the client favorably.

Based on the estimated results, the available resources of the client, and the/or client preferences and goals, the communication server may dynamically select and implement interaction protocols calculated to increase the likelihood of a target outcome. In addition, the communication server may provide or facilitate client communications in accordance with any of the selected interaction protocols.

Following these communications, the communication server may perform further behavioral tracking and data gathering for the purposes of determining or estimating the results of the communications made in response to the interaction protocol decisions. These determinations or estimations may then be stored at the communication server where they may be used for machine-learning purposes, to include reformulation or modification of any of the algorithms executed by the communication server. The determination and estimations may also be used for the purpose of defining new or updated estimates which may be used in turn for making subsequent interaction protocol decisions.

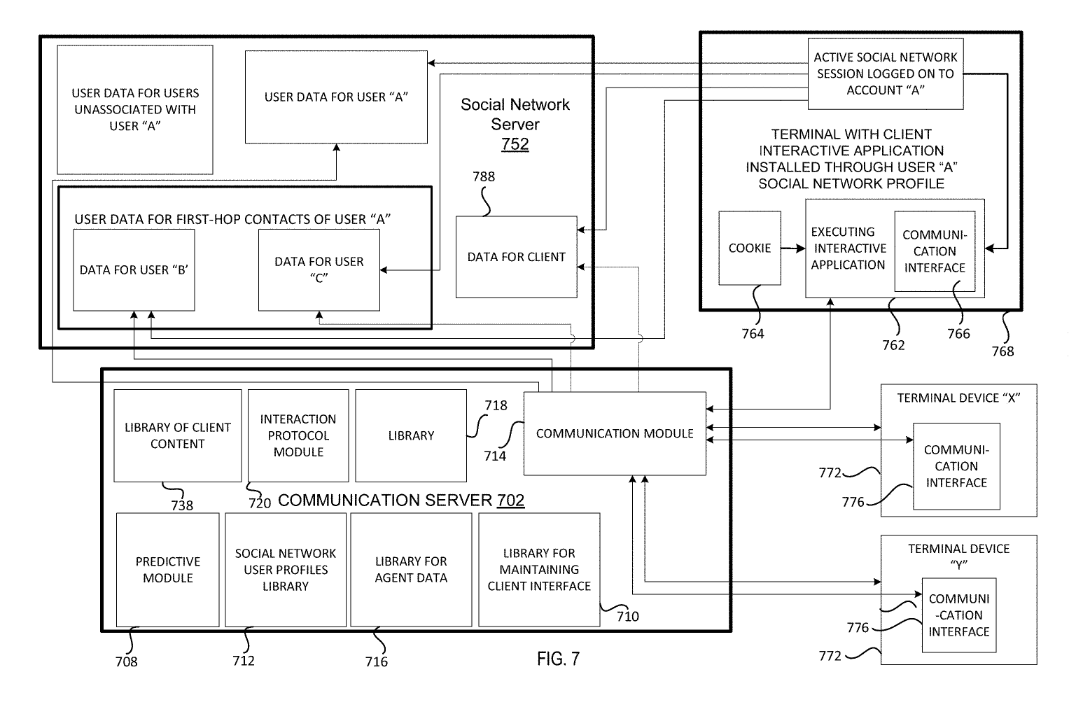

In order to perform these functions, the communication server may be connected so as to contain several different data storage libraries and functional modules. FIG. 7 displays an example communication server 702, and its connection within a network which provides communication links accessible to users of a social networking platform. As depicted in FIG. 7, the social networking platform is centrally controlled and administered at a social network server 752. For ease of explanation within this disclosure, the communication server 702 will hereinafter be described as a server which exists separately from the social network server 752, but which is configured to communicate with the social networking server 752 through at least one network communication channel. However, this disclosure is also intended to cover any other conceivable server and network arrangements which may be used to implement the techniques described herein.

For example, notwithstanding the configuration of servers 702, 752 shown in FIG. 7, this disclosure shall be understood as involving any similarly functional server arrangements in which a communication server is co-located with a social network server, or in which a social network server provides not only a social networking platform, but also additional functionality similar to the functionality of the communication server 702. Moreover, the functionality of an communication server may be obtained through the use of more than one server, each of which performs only some of the functions which will be described with regards to the server of FIG. 7. Alternatively, several servers may be connected such that each server provides all of the functionality of communication server 702. In such a case, multiple similar or identical communication servers may be used so as to distribute communication server processing tasks, increase communication server storage capacity, or provide computational capabilities.

An communication server 702 of the present disclosure may include any combination of the computational modules and data storage structures, including modules and libraries such as those depicted as being connected within the communication server 702 of FIG. 7. For example, an communication server 702 may include a interaction protocol module 704, statistics library 706, predictive module 708, and a library for storing interface data for maintaining the interfaces of clients 710. As depicted in FIG. 7, client preferences may also be stored in library 710. Client preferences may include information about the communication program goals of the client. Additionally or alternatively, the client preferences may also include information for modifying and/or updating an interface of the client maintained at the communication server.

A non-limiting exemplary list of possible client communication programs could include information depicting a number of social network users a client would like to target and/or a usage frequency of any of the various communication channels (i.e. chat, social network page posts, texting, email, etc.) available for communicating with a user.

Client communication programs may include programs which are defined for specific user groups. As one example of goals defined in this way, client preference information could indicate a preference for communicating with a group of users—such as elderly users—less than a certain number of times, or less frequently than a specified limit.

An communication server 702 may also include a library 712 for storing individual “user profiles” containing data related and indexed to specific, individual social network users. Each user profile may store many types of data, such as accumulated data, calculated data, or data generated by algorithms executed by predictive module 708. Information may, in some cases, be gathered by accessing a user's social network interface or a social network interface of a social-working associate of the user. However, several other methodologies within the scope of this disclosure may also be used to obtain such data. Hereinafter the term “user” will be used to refer to a social network user who maintains data with a social-networking server 752 with which communication 702 communicates. Thus, any person or entity for which a social network data is maintained, will be referred to using this term.

A user may use the social network to associate with a client of the communication server 702, or may be unaffiliated with the client. Moreover, any user may use the social-network to communicate or associate with first-hop contacts (also referred herein as the user's associates, connections, friends, followers, or social-networking associates of the user). A user's first-hop contacts may be understood to be users who have directly communicated with or associated with the user via the social-network. Hereinafter, reference to a social-network participant as a next-hop contact shall not imply that the participant has or has not associated or communicated with an communication server 702 client.

In some embodiments, a user profile in library 712 may also store activity data (e.g., interaction data depicting a user's browsing interactions), as well as, or in addition to, any data depicting the user's communications or interactions with, or responses to, the client's terminal devices, or any other element of a communication program on behalf of the client. Any user profile may also be used to store data generated by predictive module 708. Within any user profile, the data may include data that can be evaluated to choose an interaction protocol for communicating with the user based on the activity data.

Library 706 may be used to store statistics information or data which is determined with respect to a large group of users, rather than being specific to individual users. Although library 706 may not store data or information with respect to an individual user, when specific information about an individual user is obtained, the communication server 702 may update information in library 706 so that the user-specific information is reflected in the data. Data stored in library 706 may be used by predictive module 708 to estimate the responsiveness of individual users and groups of users.

As this disclosure will later describe in greater detail, certain evaluated interaction protocols may involve the interaction protocol module 720 selecting a particular client terminal device (e.g., agent) to contact a user. A terminal device may be selected from amongst a group of terminal devices whose likelihoods of successfully communicating with the user may be estimated by the predictive module 708. In such a situation, the interaction protocol module 720 may select a terminal device based on the estimated communication success likelihoods and the client's communication program goals, while ensuring that preferences stored in library 710 are satisfied.

Any time a terminal device selection interaction protocol is implemented, the profile of a user communicating with a particular terminal device may be updated to reflect details of the terminal device's attempt(s) to communicate with the user and the outcome of the communication attempt. This information may later be used to estimate future user responses or estimate future user interactions.

So that terminal device success likelihoods may be estimated, data depicting individual terminal devices' performance data is stored in terminal device profiles. The terminal device profiles are maintained in the library for terminal device data (e.g., performance profiles and estimates) 716. In addition to containing performance data, a terminal device's profile may also contain information about the terminal device. When information about a terminal device is stored in a terminal device profile, the predictive module 708 may use the information in conjunction with the performance data to estimate future terminal device performance in communications with specific users.

As this disclosure will subsequently explain in greater detail, the communication server 702 may maintain a social networking interface on behalf of a client. Each interface may be established, accessed, updated and monitored through two-way communications between the communication server 702 and social networking server 752. Specifically, within the communication server 702, communication module 714 may control transmissions of information to the social network server 752. Communications module 714 may access client password information or other access credentials stored in library 710. By transmitting this information to social network server 752, the communication server 702 may gain access to the social network data 788 maintained on behalf of the client.

The social network data 788 may be understood as an amalgamation of any networking features and networking information provided to the client (or, more precisely, provided to the communication server which maintains the data for the client) in connection with the client's maintenance of an active registration with the social network server 752. Additionally, the data 752 may also be understood to include any information or content which the client has provided to the social network server 752 for the purpose of maintaining the client interface.

The communication server 702 maintains client interfaces so as to display information, photographs, interactive media, or any other content which a client wishes to include on its interface. As will be explained in greater detail in subsequent paragraphs, the predictive module 708 is used to periodically estimate responses to various alternative interaction protocols for selectively displaying certain client content on the interface. The interaction protocol module 720 may then use these estimates to select an interaction protocol which is most likely to meet the client communication program goals and accommodate the client preferences stored in library 710.

Amongst other functions, a client interface may serve to enable social-networking users to connect with the client through the interface. The content on the interface may be selected to increase the percentage of users who connect with the client interface or may become interested in connecting with the client interface, message, or communication program. In this way, by identifying social networking users associated with a client interface, the communication server 702 may be able to define the scope of a communication program to users who are more likely than average to be responsive to the communication program. For example, the communication server may identify additional profiles (e.g., first-hop contacts of the user) and evaluate activity data of the additional profiles to determine which interaction protocol to execute to communicate with the additional profiles.

Additionally, by providing the interface and tracking user interactions involving the interface, the communication server 702 may be able to accumulate and synthesize important information about users who associate with the interface and the social-networking relationships they maintain. For example, on many social networking network locations, when a user associates with an interface (e.g., indicated that an interaction has been detected), the user may be able to see the defined user data, information about the user's background, and the like. Additionally, the user is linked to the sub-network of social networking contacts who are connected with the newly-associated user. An example of this linking may be understood by considering FACEBOOK©.

By identifying users who have connected with a client interface and these users' first-hop contacts, the communication server 702 may obtain a large data set which may be analyzed in any number of ways to increase the effectiveness of a client communication program. Analyzed data may be used by predictive module 708 to estimate responses to client content on the client interface, as well as to identify social networking users who are likely to associate or connect with the client interface. For example, because social networking associations and/or connections tend to involve users who have similar attributes, a list of first-hop contacts will often include users who may be or may become interested in the client's communication program. By accumulating and analyzing this data, communication for server 702 may further identify likely users within the segment of users who would associate with the client interface (e.g., “like” or register for the client's fan page). By accessing the client's social network data 752 on behalf of the client, the communication server 702 may use standard networking communications features provided through the data 752 to send messages and invitations to users identified in this way.

Moreover, within certain social networks, the communication server 702 may be able to access valuable information about users who are neither first-hop contacts nor are associated with the client interface. For example, on most social networks, access to data enables the names of at least a portion of other users to be obtained, whether or not these users have associated with the client's interface. Based on the names of these users and any other ascertainable information accompanying the names, the communication server 702 may identify likely users to whom interface messages may be selectively transmitted.

These selectively targeted communications may be designed to inform users about the interface and convince them to associate with it. In certain embodiments or modes of operation within the scope of this disclosure, the communication server 702 may be programmed in a manner intended to maximize the number of users who associate with the client. Additionally, or alternatively, the communication server 702 may be programmed so as to communicate with users in a manner intended to attract only users who are likely to be genuinely interested and/or responsive to the client's communication program communications. The communication server 702 may also be configured to communicate with users in accordance with any number of rules or preferred modes of operation specified by the client preference information stored in library 710. For example, client preference information may specify that messages and invitations to join the client's interface be submitted only to users whose social networking information indicates a residence within a targeted state.

The following example is provided to demonstrate how the communication server 702 may apply selective targeting of preliminary messages and interface invitations based on information about users who have not yet associated or connected with a client's interface.

At any point at which the communication server 702 gathers information about a user, it may build a profile of the user and save the profile in the library for social network user profiles 712. Alternatively, profiles may be initiated only after a response from a user has been received, a threshold amount of information about the user can be accessed, the user has associated with the client interface, or some other condition has been satisfied.

In one possible mode of operation, the communication server 702 constructs a separate user profile for each user who is selected to receive an initial communication or joins the client interface. In this mode, when initial communication is directed to a user, the profile of the user may be initiated so as to contain some or all of the information about the user which is accessible at that time. Initiation of the user profile also may involve recording the date, time and type or content of the initial communication. Subsequently, any response from the user may also be depicted in the user's profile. A depiction of a response could include any information about whether the user is associated with the client, activated content provided on the client's interface, and so on. Within the scope of this disclosure, other possible response data saved in a user profile could depict a volume of first-hop users joining the client interface following the joining of another user whom the first-hop contacts are associated with.

Depending on the social network being used and user data configuration settings, information about a user's connected additional profiles or social networking associates (first-hop contacts) may be accessible to the communication server 702 whether or not the user has joined the client interface. In some cases, this information may only become accessible upon the user associating with the client's interface. At any time at which information about a user's connected additional profiles or associates becomes available to the communication server 702, the communication server 702 may initiate or update the user's profile to depict some or all of these first-hop contacts.

In addition to names of first-hop contacts, a user profile may also be updated to store information about the user's relationship to any first-hop contact. When such a determination is made, the communication server 702 updates the user's profile in library 712 to detail the relationship between the profiled user and the first-hop contact. When any type of information about a first-hop contact is stored in a user profile, the predictive module 708 may analyze the information to determine its value for estimating the profiled user's likely response to various communication programs. Information determined to have predictive value may later be used in predicting and/or estimating the user's responsiveness to the communication program. The predictive module 708 may similarly analyze and/or use the information for estimating the first-hop user's likely responses to communication program.

At any time or series of times following the creation of a user profile, information in the profile may be provided to the predictive module 708 in order to generate predictive estimates about the user. Information from other user profiles, client preference information and previous data may also be provided to the predictive module 708 so that this information may similarly be used in the predictive process. The predictive module 708 may synthesize, combine and use this information in any manner suitable for obtaining valid prediction results.

Synthesizing information may include quantizing information by summarizing information using customized variables or metrics, and observations corresponding to these metrics. One example of information quantization could involve counting the number of first-hop users depicted in a single user's profile. Another example could include using a user's profile to calculate an average number of monthly client interface visits made by the profiled user. In these cases, quantization could involve initializing and updating data storage structures such as variable arrays, vectors or matrices. These structures may include elements which are each referenced to a specific user profile. When quantization is performed with respect to a user profile in the manner described above, the number of first-hop users and the monthly visit frequency may be stored in such elements referenced to the quantized user profile.

Once quantization is performed, variable arrays may be analyzed for predictive value using any number of techniques. For example, predictive values may be determined by calculating correlations amongst variables, using regression-analysis techniques, or through the use of principal component analysis. Variables determined to be informative may then be used to estimate responses to communication program communications involving various contemplated interaction protocols.

An example prediction executable by the predictive module 708 could involve analyzing a user's profile after the communication server 702 has accessed a list of first-hop contacts determined with respect to the profiled user. Here, the predictive module 108 could be used, for example, to analyze the user profile to calculate a likelihood of a first-hop contact performing a task using a communication program (e.g., linking with the interface associated with the client). Alternatively, the same likelihood could be calculated with respect to the user linked to the user profile. Regardless of the type of estimate being executed, the predictive module 708 may process inputted data or execute algorithms in any way appropriate based on the estimate at hand.

One example method of initially estimating a profiled user's likelihood of performing a target outcome will be provided for illustrative and explanatory purposes only. This example process could involve the predictive module 708 first identifying an estimate suitable for a hypothetical social-networking user situated similarly to the profiled user. This could be done by accessing previous data from the statistics library, and analyzing information in the user profile in light of this previous data (e.g., historical information). By way of example only, the statistics used in this process could include calculated correlations between various user characteristic derived from user data, and communication program outcome data depicting the results of directing previous communication programs to user's exhibiting certain characteristics.

After generating the estimate with the user profile information and previous data, the predictive module 708 could use first-hop user information in the user's profile to determine adjustments to the estimate. Here, first-hop users depicted in the user profile may be identified, and any existing profiles of these first-hop users may be evaluated. If these additional profiles indicate that the first-hop users have an unusual characteristics, the estimate may be positively adjusted based on this information.

As described previously, interaction protocol module 720 is used to evaluate predictive module 708 estimates and determine communication program interaction protocol decisions based on these estimates and client goals and preferences depicted in library 710. Whenever interaction protocol module 720 makes a interaction protocol decision with respect to a user, information about the estimate or decision may be saved in the user's profile. Also, depictions of the estimates used to make the decision or the algorithms or processes used by the predictive module 708 to generate these estimates may be saved, as well as an indication of the variables, information or data which most affected the estimate or decision. In this way, a detailed record may be maintained so that, with respect to any individual user, the past effectiveness of any algorithm or predictive technique may be understood. Based on this understanding, algorithms and predictions may be adjusted based on the user to which they will be applied.

The communication server 702 may maintain any client interface so that an interactive application 762 (the interactive application 762 is depicted after having been downloaded) is provided for download on the interface. The interactive application 762 may be code capable of being uploaded and installed within a computer or mobile device 768 utilized by a user (hereinafter referred to as a “host device” or “user terminal”) to link to the client interface. Once installed, the code may be executed within the host device 768. Execution of the code may cause the computer device 762 to periodically communicate with the communication server 702, either in response to a user command, or as dictated strictly by the installed code.

Moreover, the interactive application 762 code, when downloaded by the host device, may be accompanied by code for installing a cookie 764 on a browser within the host device. The cookie 764 may include code which executes during use of the browser, tracks user interactions with the browser, and transmits information depicting the interactions to the communication server 702.

The interactive application 762 may be attractively presented as a way for a user to obtain specialty information about the client or specialty features for interacting with the client. For example, the interactive application 762 may be presented as a way for the user to access videos or other information. The interactive application 762 code may further be written so that, when a user downloads the application, the user is prompted to provide the communication server 702 with access to control communication features and channels of the user's social-networking data. In this way, the interactive application 762, upon being downloaded, may enable the communication server 702 to obtain information about the user data contained within social networking server 752.

Many social networking platforms enable users to designate certain data access and information retrieval permissions to interactive application providers (such as communication server 702, in this case) when the user downloads an application from the provider. FACEBOOK©, for example, provides a system whereby a user can provide certain permission tokens upon downloading an application. When a FACEBOOK user downloads an application, the user may be prompted to provide the application provider with requested data access and information retrieval permissions. One such requested permission may be permission for proxy access to the user's data to post on the user's wall. Another such requested permission may be permission to obtain the user's information.

When a FACEBOOK user provides permissions upon downloading the application, a token is communicated to the application provider. The token is a unique string which identifies the user data, the granted permissions, and the application provider to which the permissions are granted. The social-network server also stores a copy of the token, in combination with the access credentials which identify the application provider to which the token is granted. Subsequently, the application provider may periodically use the token, in combination with application provider credentials, to validate the permissions granted by the user, and access the user's data in a manner within the scope of the granted permissions. Once permissions are granted and a token is provided, the application provider may use the associated permissions to obtain data or access without any further input or participation on the part of the user.

Moreover, when the social-networking server 752 is a FACEBOOK server, certain permission tokens granted to an application provider enable the provider to obtain access to a statistics library maintained by FACEBOOK to track user data. The statistics library contains detailed information and metrics about users' usage of their data, and certain tokens enable access to the previous data related to the user data from which the token was provided. Thus, when a user downloads an interactive application, and elects to provide access or information retrieval permissions to an application provider, the application provider may use the resulting token to access a wide swath of interaction data depicting the user's FACEBOOK activities.

When a user downloads the interactive application 762, a user profile may be initiated in library 712, and information about the download may be stored in the profile. Information about the download may include the download time and date, and IP address information for the terminal 768 at which the download occurred. Alternatively, if a profile has already been activated for the downloading user, the profile may be updated to reflect the information about the download.

Following the download, the communication server 702 may periodically update the user profile to reflect any accessible information about the users' activities. This information may include any such information which may be obtained from social-networking server 752, using any authorization tokens issued in response to permissions granted by the user.

The information may also include data depicting the user's browsing activities tracked by the cookie 764, as well as information about the user's utilization of the interactive application 762. By cross-referencing the IP addresses in user profiles with an IP address accompanying a transmission of tracking data from a user terminal 768, communication server 702 may properly attribute data to the appropriate user and select the appropriate user profile in which to store the data. For example, the interactive application 762 code may be designed to cause the host device 768 to transmit to the communication server 702 each time the user activates or interacts with the application 762. The transmission may include information about interactive application 762 content or features which the user interacts with. In this way, additional sources of data depicting a user's interaction with client content may be obtained for the purpose of estimating future responses to potential communication programs.

The cookie 764 may also be used to track the user's browsing activities within the social networking site. This browsing information may also be transmitted to the communication server 702. The communication server 702 may, amongst other things, analyze the information to identify the user's social-networking first-hop contacts who receive the most social-networking attention from the user. In this way, a user's profile may be periodically updated with information depicting the amount of attention the user gives to the various social-networking connected additional profiles and associates identified in the profile. This information may be used to update statistics stored in library 718. The information may also be evaluated by predictive module 708 in generating estimates related to the user's responsiveness to a communication program, or to a first-hop contact's responsiveness.

As described above, library 716 may be used for storing information related to terminal devices working on behalf of the client to provide targeted communications to users identified by the communication server 702. These terminal devices may refer to agents working at a computer terminal 772 with real-time network communications capabilities. Through network communications channels, the communication server 702 continuously monitors the terminal devices' activity and serves as a relay mechanism between terminal devices and the social-network users whom they contact.

In one embodiment, the interactive application 762 provided on the client interface may include code for activating a communication session (e.g., chat) or other messaging interface 766 for using a communications channel between the user and a terminal device. The interface 766 may be controlled and activated by commands transmitted from the communication server 702. When the interface 166 is active, it enables 2-way communications between the user and a terminal device. The communications, whether transmitted from the host device 168 or computer terminal 772, may be relayed by the communication server 702. In this way, the communication server 702 may analyze an ongoing communication session between a user and a terminal device.

In addition to control of the communication interface 776, the communication server 702 may be configured to control access to the channel. In other words, the communication server 702 may select a terminal 772 to have communications access to the channel and may activate or deactivate this access. The communication server 702 may access additional communication channels (referred to hereinafter as “terminal device notification channels”) which may be used to inform selected terminal devices when they will placed in a communications session through an activated channel. In this way, the communication server 702 may select a terminal device to communicate with a user via the 2-way communications channel. Without the user knowing, the communication server 702 may use a terminal device notification channel to provide the selected terminal device with information about the user and instruct the terminal device to provide a greeting to the user.

The communication server 702 may use browsing and interaction data provided by the cookie 764 to schedule a communication session to occur at an advantageous time for the client communication program. For example, information gathered by cookie 164 may enable the communication server 702 to prompt a terminal device-initiated communication when the user is visiting a network location (e.g., website) operated by the client.

If the terminal device communicates with the user by providing a greeting which the user responds to, an ensuing two-way communication session between the terminal device and user may be managed and monitored by the communication server 702, which facilitates the communication by relaying messages in both directions. During or after the communication with the user, the communication server 702 may update the user's profile within library 712. Updating the user profile may involve adding information about the user's response to the terminal device's greeting, information depicting the user's or terminal device's communications, an outcome of the communication or any other information about the user learned from the communication. The communication interface 776 provided to the terminal device may include a communications feature which enables the terminal device to provide the communication server 702 with additional information about the communication session. As will be explained in more detail in subsequent paragraphs, this information may be used at the communication server 702 as a mechanism for verifying the validity of artificial intelligence estimating based on algorithmically derived data obtained during the communication.

For example, based on the monitored communications, the communication server 702 could generate and store data depicting the length of the communication, keywords used by the terminal device, a number of questions asked by the user, a price requested or indicated as acceptable by the user, the name of the terminal device or any other information which could be of use in performing future estimating with regard to any users, or determining future communication programs. The communication server 702 could analyze text communicated by the user to determine if the user has decided to make a connection with the client's interface or obtain additional information about the client. Simultaneously, the communication server 702 may analyze browsing information generated by the cookie 764 on the user's computer to determine if the user has decided to perform a particular action (e.g., select a link).

While an ongoing communication session is monitored, the predictive module 708 may execute algorithms which analyze the communications in an attempt to determine current information about the user. For example, the predictive module 708 may execute algorithms which apply machine learning techniques to analyze text provided by the user. The algorithms may be executed so as to estimate the user's sentiment towards the client's communication program and information provided by the terminal device. Once such estimates are generated, additional algorithms or algorithmic modules can use the estimates, in conjunction with any other information stored by the communication server 702, to predict which content the user will be most responsive to. Additionally, or alternatively, the algorithm could predict future user behavior in a more general manner. For example, see U.S. Ser. No. 13/961,072, filed in the U.S. Patent & Trademark Office on Aug. 7, 2013, entitled “Method and System for Engaging Real-Time Human Interaction Into Media Presented Online,” the disclosure of which is incorporated by reference herein in its entirety for all purposes.

When a predictive module 708 algorithm is used to estimate user responses in this way, the communication server 702 may use a terminal device notification channel to transmit a message to the terminal device. For example, such a message could recommend that the terminal device's communications with the user emphasize content determined by the predictive module 708 to have a high likelihood of eliciting favorable user responsiveness. As another example, a message could simply inform the terminal device about the user's estimated responsiveness.

During a communication session between a terminal device and user, or anytime an algorithm at communication server 702 estimates any aspect of a user's responsiveness in any way, the communication server may identify content to provide to the user by referencing the library for storing client content. Within the communication server 702, the library for storing client content 138 stores content indexed to searchable instructions. The instructions specify when, how or to whom the content should be provided. Content in library 738 may be initially provided by the client and marked by the client with the instructions specifying the content to transmit to certain users or in certain situations. When content from library 738 is recommended by communication server 702 and provided by a terminal device to a user, the communication server 702 may generate and store data depicting usage of the content. Over time, the communication server 702 may analyze this data to determine that certain content is effective or ineffective for the client's communication program. When such a determination is made, the predictive module may execute one or more algorithms to analyze potential modifications to the content, and determine which modifications will result in an improved communication program for the client. The communication server 702 may then modify the content in library 738 based on the estimating results.

Each instance of content may be stored with searchable index or indexing parameters. The indexing parameters may be formatted so as to enable searching for content using predictive module outputs depicting a user's responsiveness prediction. This outputted information may be compared to indexes or indexing parameters in library 738. When a match with an index is determined, the stored content associated with the index may be accessed and communicated to the terminal device. In this way, when an estimate indicates a certain characteristic of a user, the communication server 702 can easily identify and access content prescribed for a user who has that characteristic. The terminal device may then use or emphasize this content in the ongoing conversation with the user. Also, in certain circumstances, the terminal device may directly forward the content to the user.

Prescribed content stored in library 738 may take any form which is communicable to a user. For example, stored content may be critical words, phrases, questions, or messages which are preferred by the client or which have been determined to be effective in particular situations. Stored content could also include URL links to network locations storing information about a resources or objects.

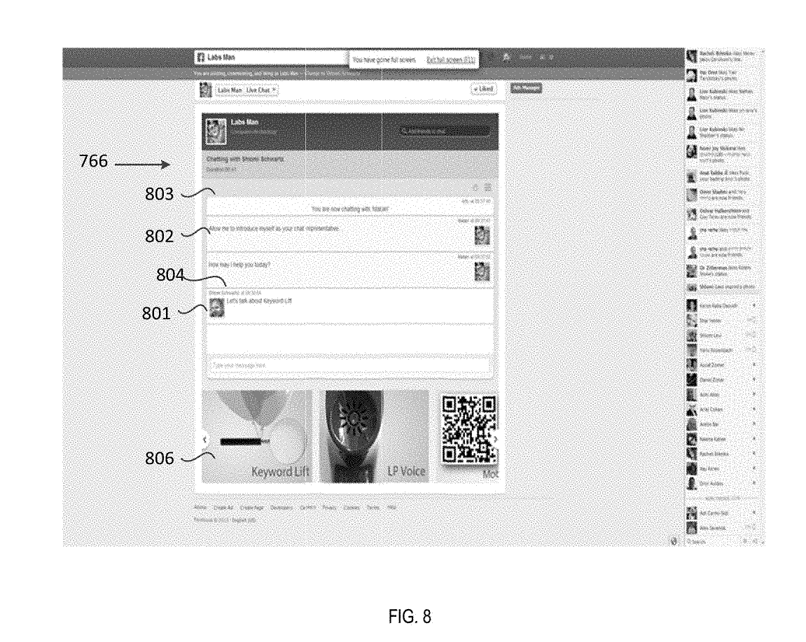

FIG. 8 is an example user communication interface 766 being operated by a social-networking user at a user terminal 768. As depicted, the user communication interface 766 enables the user 801 to see messages 802 sent by a terminal device and information about the terminal device 803. The communication interface also enables the user to generate messages 804 which are sent to the terminal device. FIG. 8 also depicts the display of content 806 from library 738. The content displayed at 806 may be content which was selected by the communication server 702 from within library 738, provided to the terminal device for selection along with other content, and then selected by the terminal device to be presented to the user. Alternatively, the content 806 may be content which was selected at the communication server 702 and transmitted directly to user terminal 768 for display at the user communication interface 766, without any input being provided by the terminal device. Although not explicitly depicted in FIG. 8, the user may interact with the content 806 during the communication session, and may use the communication interface to discuss the content with the terminal device.

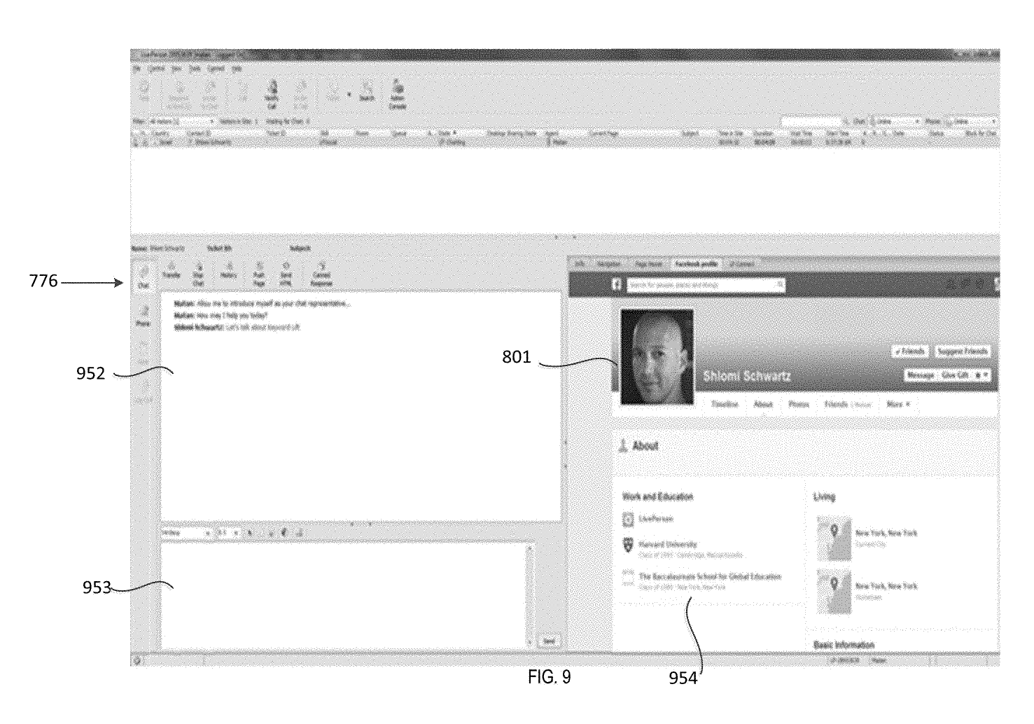

FIG. 9 is a screenshot depicting a terminal device communication interface 776 being operated by an agent at a terminal device. The terminal device may be a terminal such as the terminal depicted at 772. As depicted at 952, the terminal device interface provides a feature 953 which enables the terminal device to provide text for communicating with the user in chat communications and sending informative messages to the user as defined by a client communication program. The terminal device interface also includes an informational component 954 which displays information about the user. Prior to being displayed, communication server 702 retrieves this user information from the user's profile in library 712, and the communications module 714 forwards the information to the terminal 772.

As mentioned previously, by being connected with control of the various channels and interfaces involved in initiating and maintaining a terminal device-user communication session, the communication server 702 may select a terminal device to communicates with a user and may activate a communications capability at the selected terminal or workstation 772. In addition to this capability, communication server 702 may store and aggregate user information or performance information with respect to individual terminal devices. This information may be stored in the library for terminal device performance, profiles and estimates 716.

Terminal device data may be quantified using one or more statistics which depicts a level of terminal device success in achieving the client's objectives. Additionally or alternatively, multiple such data may be combined within an algorithm to generate an overall score.

When predictive module 708 determines that a particular user should be communicated with using chat communication, the predictive module 708 may then execute a terminal device selection technique for identifying a terminal device with the highest likelihood of successfully communicating with the user. Any number of terminal device selection techniques may be used for this purpose.

One such technique may be used when previous terminal device performance is documented with respect to user groups or other user categories. In this case, library 716 may store and periodically update a separate terminal device performance score so as to depict a terminal device's previous instances of communicating with users from various user or groups. A terminal device's performance score for a group indicates only the terminal device's success in communicating with users who belong to the group. In this case, terminal device selection may involve analyzing the user's profile to determine which group the user belongs to. Next, each terminal device's performance score with respect to a characteristic is examined, and the terminal device with the highest performance score is selected to communicate with the user.

As explained above, when a terminal device communicates with a user, the communications between the terminal device and user and the user's response to the communication are tracked. Following the communication, library 716 is updated by adding data to depict the communication and its results. Based on this data, the terminal device's group score is adjusted. Also, the library 718 may be updated with general information (i.e. information not indexed to the user or terminal device) about the recently completed communication.

The communication interfaces used by the terminal device and user may be configured to facilitate 3-user communication sessions. It will be appreciated that communication interfaces may be configured to facilitate communication sessions with any number of users (e.g., three or more). A 3-user communication session may involve the terminal device, user, and a social-networking first-hop contact of the user. For example, when the communication server 702 activates a communication channel between a terminal device and user, the communication server 702 may further transmit information causing the terminal device or user's interface to display a list of the user's connected additional profiles who have downloaded the client interactive application 762. The list of the user's connected additional profiles may include relevant information about the additional profiles.

When provided with the additional profile list, the terminal device may select an additional profile and suggest that the user invite the selected additional profile to the communication session. If the user agrees to invite the selected additional profile, information depicting the selection is transmitted from the user's terminal 768 to the communication server 702. The communication server 702 may then activate a communication interface 766 on the additional profile's computer. Additionally, the communication server 702 may provide the terminal device with additional information from the additional profile.

Any subsequent communications received at the communication server 702 from either of the three parties are analyzed at the communication server 702 and transmitted for display on the communication interface of every other user to the communication. In this three-user context, the communication server 702 may apply all of the same capabilities described above with respect to a two-user communication session. However, the communication server 702 may apply these same capabilities to the additional profiles, as well as to the inviting user. Thus, the communication server 702 may analyze the additional profile's communications in light of other information or data gathered with respect to the additional profile (e.g., friend of follower of the user). The prediction module 708 may estimate the user's connections to additional profiles or predict the responsiveness of the additional profiles. Additionally, the communication server 702 may analyze information about the additional profile in conjunction with information about the user.

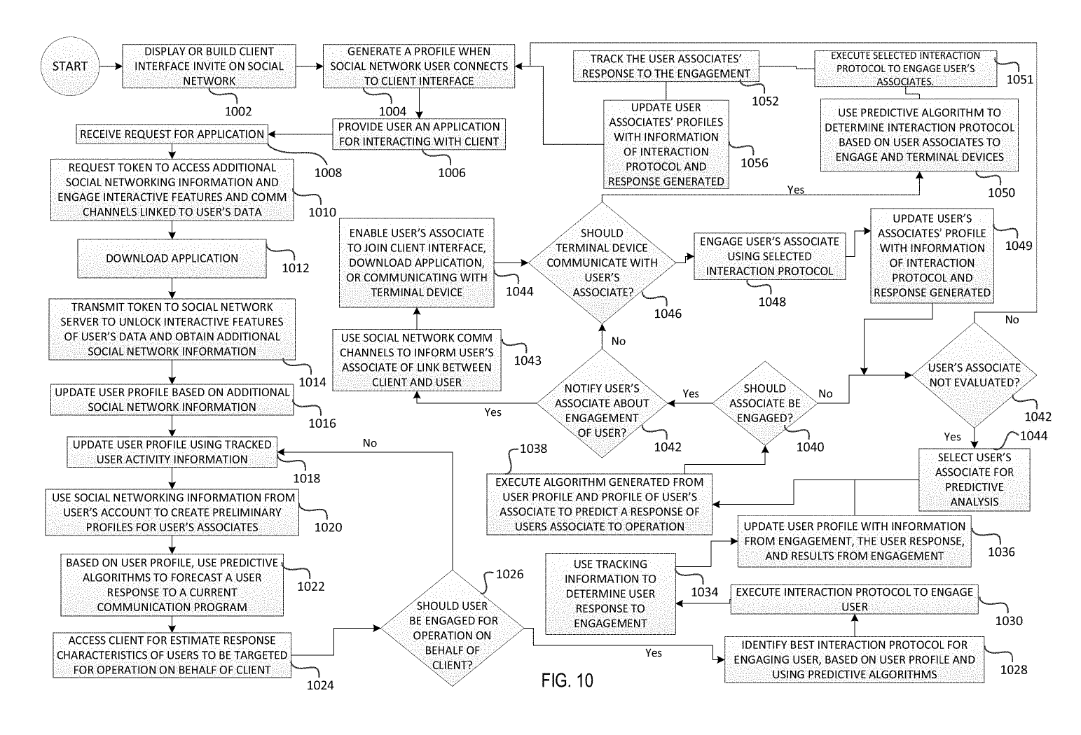

FIG. 10 is a flow diagram which illustrates example operations of a communication server in accordance with certain of the aspects of the present disclosure described above. At 1002, the communication server 702 displays or promulgates a client invitation on a social network location. As describe earlier, displaying a client in this manner may be done by connecting with a social-networking server to create a client social-network data, such as the data depicted at 788 in FIG. 7. At 1004, the communication server 702 and monitors the client data 788 to detect when a social network user associates or connects with (e.g., registers with, follows, etc.) the client's interface. When a user associates with the client interface, the communication server 702 initiates a user profile containing information about the user. At 1006, the communication server 702 provides a feature on the which enables the user to download an interactive application for interacting with client. At 1008, the communication server receives a request from the client to download the interactive application.

At 1010, in response to the download request, the communication server 702 requests that the downloading user grant a permission token to allow the communication server 702 to access social networking information related to the user, and to allow the communication server 702 to provide interactive features and communications channels linked to the user's data. At 1012, the communication server 702 downloads installation code to the user's terminal 768. The installation code causes the application 762 to execute on the user's computer 768, and installs a cookie 764 within the user's browser so that the user's browsing activities may be tracked. At 1014, if the user has granted the permission token described at 1010, the communication server 702 uses the permission token to access information about the user which is stored by social-networking server 752. The token information is also used to unlock interactive features of the user's social-networking data.

At 1016, the communication server 702 updates the user profile so that the profile includes any additional user information received from the social-networking server 752. At 1018, the communication server 702 begins to track the user's social-networking browsing activities. Tracking may be performed by monitoring the user's social-networking page, as well as by receiving data accumulated by the cookie 764 and transmitted to the social networking server 702.

At 1020, the communication server 702 may review the user's social networking to ascertain first-hop contacts (“associates”) of the user, as well as any obtainable information about specific associates of the user. Based on this review, the communication server 702 creates preliminary profiles for each of the user's additional profiles. Any of the preliminary profiles may later be updated in response to additional information about an associate being obtained, or in response to an associate linking to the client or downloading the client interactive application. Also, as described earlier, the information in the preliminary profiles may also be used for a variety of predictive purposes.

As depicted at 1022, the communication server 702 predictive module 708 uses predictive algorithms to estimate how the user will respond to a current publicity communication program on behalf of the client. Here, for example, the predictive module 708 could predict how the user will respond to being communicated with in a communication session by a terminal device, or how the user will respond to seeing a series of ads, banners, or email messages currently being used by the client. The predictive module 708 may analyze a variety of different communication program and individually estimate results of applying each interaction protocol to communicate with the user. At 1024, the communication server 702 accesses client preference information in library 710. This preference information indicates desired estimate response characteristics of users to be targeted as part of the client's communication program.

At 1026, the communication server 720 determines whether the user should be communicated with on behalf of the client. This determination is made by comparing the client preferences accessed at 1024 and the estimated results determined at 1022. If the estimated results are not sufficiently promising in light of the client preferences, the communication server 702 determines that the user should not be communicated with at the present time. In response to this determination, the communication returns to 1018, and again performs the subsequently depicted steps in order to accumulate more information about the user and any new user associates, and obtain updated predictions about user responses to subsequent client communication programs.

Referring again to 1026, if the estimated results are sufficiently promising in light of the client preferences, predictive module 708 executes predictive algorithms at 1028 to determine a best interaction protocol for communicating with the user. The predictive algorithms may evaluate various interaction protocols in making this determination. The various evaluated interaction protocols may be unique in any number of ways. For example, the interaction protocols may differ in the medium used for communicating with the user, the message contents, communications timing, or any other aspect of communication capable of being altered to improve results.

At 1030, the interaction protocol which is selected is used to communicate with the user. At 1032, the communication server 702 obtains tracking data depicting browsing activities of the user. At 1034, the communication server 702 uses this tracking data to determine the user's response to the communication. Although not depicted, if the user is communicated with by a terminal device using a communication interface 766, chat communications sent by the user or the terminal device may also be analyzed at 1034 to determine the user's response to the communication. Additionally, in this case, the terminal device may transmit communications indicating the terminal device's impressions. These communications may be transmitted to the communication server 702 using the terminal device notification channel and may be analyzed at the communication server 702 in order to further determine the user's response to the communication.

At 1036, communication server 702 accesses the user profile in library 712 and updates the profile by adding information about the user's response to the communication. The information may indicate, amongst other things, the user's interaction with content provided as part of the communication, the identity of any terminal device who assisted the user, and whether the communication resulted in an outcome sought by the client, such as an additional communication being scheduled, or any other outcome.

At 1038, an iterative process commences. During the process, the communication server 702 reviews the profiles of the user's first-hop contacts (e.g., the user's “associates” or additional profiles) in order to identify additional users to communicate with as part of the communication program. As depicted at 1038, the predictive module accesses information from the user's profile in library 712, and information in the profile of an associated of the user. A predictive algorithm is executed to estimate the user associate's response to the communication program. The estimates may include estimates specific to various candidate interaction protocols for providing communication program content. These candidate interaction protocols may include some or all of the same candidate interaction protocols evaluated with respect to the user, as described at 1028. The candidate interaction protocols may be differentiated based on the medium for providing content, the use of a terminal device to provide content, the message, information, images, timing, display location, or key words used, or in any other manner. In evaluating a interaction protocol, the prediction information generated by the predictive module may include responsiveness likelihoods.

One or more of the evaluated interaction protocols may involve informing the user's associate about the most recent communication with the user. Informing an associate about a past communication may involve, amongst other things, sending a message to the associate or posting information on the user's or associate's social-networking page. Regardless of the communication method selected for transmitting the message, this content may be used to imply that the user would like to be associated or linked with the client's interface. The message may contain additional information about the client, a link to the client's and a link for downloading the client's interactive application 762.

In instances in which communication with the user has resulted in particular outcome, the content can describe that outcome. Furthermore, at 1038, the communication server 702 may use the user associate's user information to determine if the associate has been responsive to any current or past communication program operated by the client. If the associate has been responsive, these associates may be informed about the client's communication with the user in a predefined manner.

At 1040, communication server 702 uses the prediction results obtained at 1038 to determine whether the user's associate should be communicated with as part of the client's communication program. If the communication server 702 determines that the associate should not be communicated with (e.g., engaged), the communication server 702 determines, at 1042, whether there additional unevaluated profiles for other user associates for which the predictions at 1028 have not yet been made. If there are additional associates for whom a prediction has not been made, an additional user associate is considered at 1044, and the predictive evaluation of this associate commences at 1038 in the same manner described previously for the originally evaluated user associate. Alternatively, if there are no remaining associates of the user, the process returns to 1004, thereby allowing the process to be continuously executed. In this way, additional data about the user and the user's associates may be obtained so that communication server 702 machine-learning algorithms and prediction parameters may be updated, and so that the possibility of targeting these social-networking participants may be reevaluated as new content, interaction protocols, and client preferences are provided, or when a new client communication program begins.

Referring back to 1040, if the communication server 702 determines that the associate should be communicated with as part of the communication program, the communication server 702 then determines whether the associate should be informed about the communication with the user. If the communication server 702 determines that the associate should be so informed, the process continues at 1042 and 1044, prior to 1046. Otherwise, the process proceeds to 1046.

At 1043, the communication server 702 informs the user associate about the communication with the user. In order to provide this information, the communication server 702 uses the client's social networking data and social-networking communication channels provided by the data. At 1044, the social network server 702 provides the user's associate with additional information or content so that the associate can communicate with the client's communication program if the communication provided at 1042 is successful. This additional content may include a link for accessing or associating with the client's interface, a link for downloading the client's interactive application 762, or a link to the client's network location. At 1046, the communication server 702 decided if a terminal device should be used to communicate with the user's associate. If the communication server 702 determines that terminal device communication should not be executed, a best communication protocol or interaction protocol not involving a terminal device is selected at 1048. Also, at 1048, the user's associate is communicated with according to the selected interaction protocol. Also, if the user associate has downloaded the client's interactive application 762, the associate's response to the communication is tracked using browsing data accumulated by a cookie within the associate's browser. Subsequently, the user associate's profile is updated at 1049 to depict the communication targeted to the associate and the interaction protocol used in the communication. Also, any obtained data which depicts the associate's response to the interaction protocol may be added to the associate's profile. After updating the profile at 1049, the communication server re-executes step 1042 and subsequent procedures in the iterative process already described.

Referring again to the determination at 1046, if the communication server 702 determines that a terminal device should communicate with the user's associate, the prediction module algorithm is executed at 1048 to determine an interaction protocol from a plurality of interaction protocols which involves a terminal device. Here, determining an interaction protocol may involve selecting a terminal device who is best-suited to communicate with the user's associate. As described above, selecting a best-suited terminal device may be done by evaluating the performance of each available terminal device.

At 1051, the user's associate receives a communication in accordance with the selected interaction protocol (e.g., chat message, direct message, and so on). At 1052, the user associate's response to the interaction protocol is tracked. As described previously, a social-networking participant's response to a chat communication may be tracked using a cookie installed on the participant's browser. The response may also be tracked in other ways, including by using terminal device input provided to the communication server 702 through the terminal device notification channel. At 1056, the user associate's profile is updated with information depicting the interaction protocol used to target the associate. The profile is also updated with information indicating the associate's response to the targeted communication. Subsequently, the process continues by a return to 1004, at which point the process is indefinitely re-iterated with respect to the same social-networking user or any other social networking user.

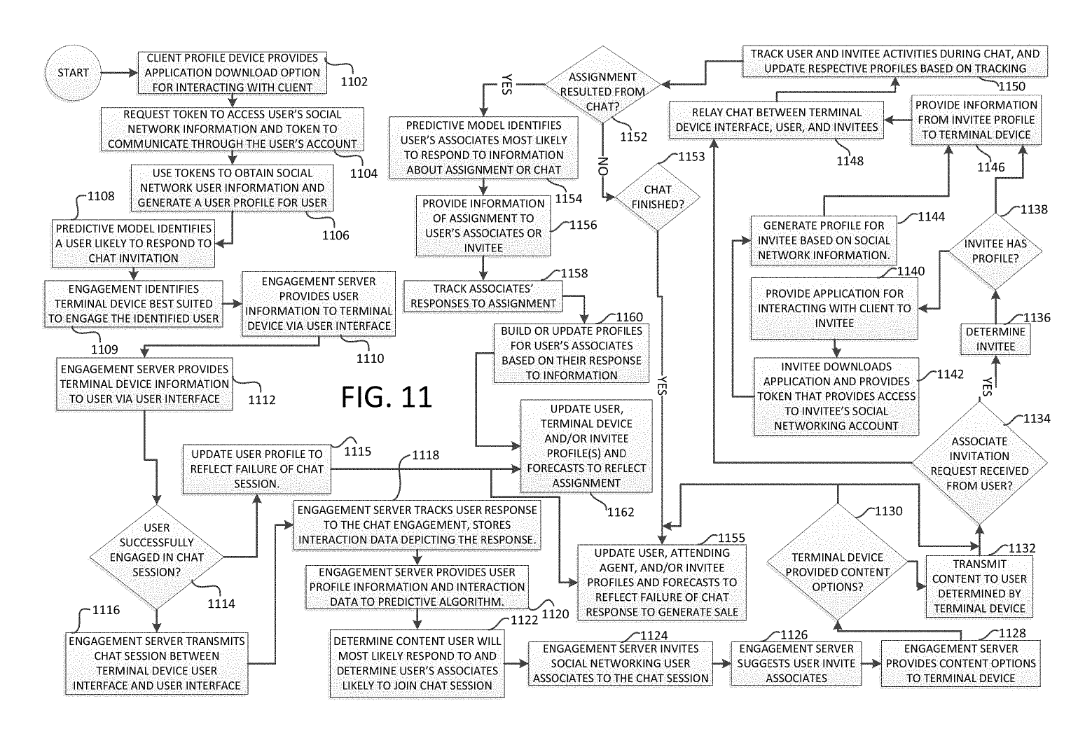

FIG. 11 depicts an additional sequence of example operations which may be performed by the communication server 702, in accordance with certain of the techniques disclosed herein. The example operations of FIG. 11 commence at 1102. At 1102, the communication server 702 maintains a client interface controlled through a social-network data stored at social-network server 752. The interface includes a feature which enables client users to download an interactive application 762 for communicating and interacting with the client. The communication server 702 may be configured to upload the code to any user who elects to download the interactive application 762.

At 1104, in response to any user initiating a download of the interactive application 762, the communication server 702 requests that the downloading user grant a permission token. A permission token—when granted—allows the communication server 702 to access any non-public social networking information about the user which is stored in social-networking server 752. A granted token also allows the communication server 702 to access social networking communications channels provided through the downloading user's data.

At 1106, after a token has been granted in response to the request at 1104, the communication server 702 uses the granted token to access any non-public information about the granting user which may be stored at the social-networking server 752 and made available to token holders. Also, at 1106, the communication server 702 initiates a user profile for each user who has downloaded to the client's interactive application 762. If social-networking information about any of these users is made available by social-network server 752, the information is stored in the profile of the user to whom the information corresponds.

At 1108, the communication server 702 analyzes the user profiles and previous data to determine a user (or multiple users) who is most likely to respond to a chat invitation. Then at 1109, predictive module 708 individually analyzes each of the client's terminal devices and chooses a terminal device to communicate with the user. At this stage, each analysis of a particular terminal device may involve predicting a likelihood of the terminal device successfully communicating with the user through chat communication. In predicting likelihoods of terminal device success and selecting the terminal device most likely to be successful, the predictive module may evaluate information in the user's profile, and terminal device performance data in library 716.

At 1110, communication server 702 transmits information about the user to the selected terminal device. In order to perform this transmission, the communication server 702 executes the communication module 714 and the terminal device notification channel. The terminal device may use the information provided by the communication server 702 in order to make informed decisions about how best to communicate with the user. At 1112, after the terminal device has communicated with the user by sending a chat greeting, communication server 702 transmits information about the terminal device to the user. This information may include the terminal device's name, location, expertise, or any other terminal device information which the client opts to provide targeted users with.

At 1114, communication server 702 monitors the chat communication channel to determine if the user has responded to the terminal device's communication attempt. If the communication is not successful, the communication server 702 updates the targeted user's profile to reflect the unresponsiveness, as depicted at 1115. The communication server 702 adds information to the profile which depicts any number of aspects of the failed interaction protocol (e.g., strategy) and the communication attempt made by the terminal device. In this case, as indicated in FIG. 9 by the reversion to 1108 following 1114, and by the procedures depicted subsequent to 1108, the communication server continues to periodically predict user responses to chat invitations, target chat communications to selected users, accumulate information about users and communicate with users based on the data and predictions.

However, if, at 1114, a determination is made that the user has responded to the chat communication, the communication server 702 then relays chat communication between the terminal 772 and user terminal 768, as shown at 1116. As described earlier, the communication server 702 may analyze and store any chat communication which is relayed. As part of this analysis, the predictive module 708 may estimate the user's responsiveness.

As depicted at 1118, the communication server 702 tracks the user's response to the chat communication. The user's response may be determined using browsing data accumulated by a cookie executing within the user's browser. The response may also be determined based on the communications made by the user during the communication session, as well as, or in addition to information provided by the terminal device via the terminal device notification channel.

At 1120, the communication server 702 provides the predictive module 108 with information from the user's profile in library 712. This information may include information which depicts the user's response to the chat communication. Simultaneously, the predictive module 708 may also have access to the library of client content 738, as well as profile information for any of the user's first-hop contacts. At 1122, the predictive module 708 analyzes the information using a predictive algorithm to predict client content most likely to elicit a desired response from the user.

The predictive algorithm 1122 also identifies social networking associates of the user who are most likely to be responsive to an invitation to join the communication session in which the user is involved. The predictions with respect to associates of the user may involve calculating several different likelihoods with respect to each associate. For example, for any single associate, the predictive algorithm may be used to calculate a likelihood of the user agreeing to invite the associate to the conversation, a likelihood that the associate will join if invited, and likelihoods that the associate's participation will worsen (e.g. cause the user to defer an action which otherwise would have occurred) or improve the outcome (e.g. cause the user to perform an action that would otherwise not have occurred) of the conversation for the client. A cumulative score may be calculated for each of the associates based on a combination of these likelihoods, and associates of the user may be ranked in order of cumulative score. One or more associates with a highest cumulative score may then be individually evaluated. Individually evaluating an associate may be performed by comparing the associate's cumulative score to a threshold score stored within the library for client preferences. Any associate for whom a cumulative score is above the threshold may be recommended to the user in order to encourage the user to invite the recommended associate to the communication session (e.g., chat).

At 1124, the communication server 702 communication module 714 transmits 3-user chat invitation functionality information to the user computer. The transmitted information causes an invitation feature to be displayed at the user's communication interface. The feature enables the user to invite an additional profile or associate to participate in the communication session with the terminal device. At 1126, the communication server 702 communication module 714 transmits information to the user. At the user's terminal, this information causes the communication interface to display a suggestion that the user invite one or more of the recommended associates to the communication session.

At 1128, communication server 702 communication module 714 transmits information inform the terminal device about the content previously chosen by the communication server predictive module at 1122. The content information causes content options to be displayed to the attending terminal device at the terminal device's interface. The content options enable the terminal device to present to the user, at the terminal device's election, any of the content chosen by the communication module.

At 1130, the communication server 702 communication module 714 examines communications from the terminal device to determine if content has been selected by the terminal device. If content has been selected, the communication server 702 communication module 714 transmits the selected content to the user, based on the selection made by the terminal device. The transmission of the selected content is depicted at 1132.

At 1134, the communication server 702 communication module 714 monitors transmissions made from the user terminal, and ascertains whether an associate invitation request has been made by the user. For so long as an invitation request is not received and the communication session continues, the communication server 702 iteratively executes steps 1148-1154 and step 1134. Steps 1148-1154 will be explained in greater detail in subsequent paragraphs.

However, it an invitation is received at 1134, the communication server determines the invitee at 1136. At 1138, the communication server 702 evaluates library 712 to determine if a profile for the invitee exists. If a profile does exists, the communication server communication module 714 transmits relevant information from the invitee's profile to the terminal device. This information may include information about the invitee's name, age, interests, background, location of residence, or any other information which could potentially assist the terminal device in furthering the goals of the client's communication program during communications with the invitee and user. At 1140, if an invitee profile does not exist in library 712, the communication server 702 communications module transmits information for soliciting the invitee to download the mobile application 762 for interacting with the client.

At 1142, after the invitee has requested to download the application 762, the communication server 702 communication module 714 downloads the application code to the invitee computer, and obtains a token from the invitee. Here, the token is obtained in a manner similar to the process described at 1106, in which a token was obtained from the user. As is further depicted at 1142, once the token is obtained, communication server 702 communications module 714 uses the token to access social networking information associated with the invitee's social networking data (e.g., social network account), and stored at the social-networking server 752.

After social-networking information from the invitee's data is obtained, the communication server 702 creates and stores a profile of the invitee, as depicted at 1144. The profile is stored in library 712 and is initiated so as to contain the social-networking information about the invitee which is obtained from social-networking server 752. Additional information about the invitee may be saved in the invitee profile. This additional information may include, amongst other things, information depicting the invitation of the invitee to the communication session, information indicating that the invitee was responsive to the invitation, or information identifying the terminal device and user participating in the conversation at the time of the invitation. If the invitee was suggested to the user at 1126, the invitee profile may indicate this fact, in addition to the prediction module algorithm or algorithmic parameters which were used when the prediction module selected the invitee to be suggested to the user, at 1122.

At 1146, the communication server 702 communications module 714 transmits information from the invitee profile, as was described above. At 1148, the communication server 702 communications module relays chat communications between the terminal device communication interface 776, the user communication interface 766, and the communication interface of a participating invitee, if an invitee is present. When any user to the conversation transmits communication text, the communication text is analyzed at the communication server 702 and forwarded by communications module 714 for display at each user's interface, along with an indication of the user who provided the text. As was described previously with regards to communication server 702 analysis of communication text, the analysis may include estimating the responsiveness of the communication session participants, and so on.

At 1150, the communication server 702 tracks user and invitee (if an invitee is participating) interactions and behaviors during the communication session, and updates the user and invitee profiles based on the interactions and behaviors. Also, at 1150 the user and invitee profiles are updated to reflect the user and invitee interactions and behaviors, respectively.

At 1152, the communication server 702 determines whether a target outcome or other intended outcome has resulted during the chat communication. If a target outcome has not yet resulted, the communication module 702 determines, at 1153, whether the conversation has terminated. This determination may be made based on input provided by the terminal device, via the terminal device notification channel. Alternatively, the determination may be made based on analysis of the communications previously related between the parties to the conversation.

If, at 1153, the communication server 702 determines that chat communication is continuing, a subsequent iteration of steps the process returns to 1134, and the steps depicted at 1134 and thereafter are reiterated. However, if the communication server 702 determines that communication has ceased, the user and invitee (if applicable) profiles in library 712 are updated at 1155 to reflect that an intended outcome did not result from the communication. In this case, the procedures beginning at 1108 are then iteratively repeated so that the user and invitee may later be considered for an additional chat communication, and so additional users may be targeted using chat based on the information obtained from communicating with the user and invitee.

If, at 1152, communication server 702 determines that the chat communication has resulted in a target outcome, the predictive module is used at 1154 to identify associates of the user or invitee who are most likely to be responsive to information about the action performed by the user. To perform this identification, the predictive module may analyze the profiles of the user, as well as previous data from library 718. At 1156, if any of the identified associates are predicted to be sufficiently responsive, the communication server 702 communications module uses communication channels provided by the social network in order to communicate with the identified associates, and inform them about the sale.

At 1158, the communication server 702 tracks the associates' responses to the information about the sale. Here, the responses may be tracked by scanning a list of client members to determine if an associate has joined the following distribution of the sale information. Alternatively, some of the associates informed about the sale may have already joined the and downloaded the client interactive application 762. In the case of these associates, the cookie installed on these associates' machines may provide additional information for response tracking. Also, response tracking may be performed by analyzing social-networking messages sent to the user for indications about whether these participants have been asked about the client.

At 1160, the communication server 702 initiates and stores a profile in library 712 for each user or invitee associate selected to receive information about the communication session. Each initiated profile for a user or invitee associate stores information depicting that person's response to the information about the chat communications. If there are any user or invitee associates who were informed about the chat communication and for which a profile already exists, the existing profile is updated to depict the associate's response to information about the user's chat communication.

At 1162, the profiles of the user and invitee in library 712 are updated to reflect details of the target outcome resulting from the chat communication. Also, the library for terminal device performance 716 is updated to reflect details of the successful outcome obtained by the terminal device. Subsequently, the procedures beginning at 1108 are iteratively repeated so that the user and invitee may later be considered for an additional chat communication, and so that additional users may be targeted for chat communications, based on the information obtained from communicating with the user and invitee.

The methods, systems, devices, implementations, and embodiments discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

The use of “capable of”, “adapted to” or “configured to” herein is meant as open and inclusive language that does not prevent devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

Specific details are given in the above description to provide a thorough understanding of the embodiments. However, it is understood that the embodiments can be practiced without these specific details. For example, circuits can be shown as block diagrams in order not to obscure the embodiments in unnecessary detail. In other instances, well-known circuits, processes, algorithms, structures, and techniques can be shown without unnecessary detail in order to avoid obscuring the embodiments.

Implementation of the techniques, blocks, steps and means described above can be done in various ways. For example, these techniques, blocks, steps and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions described above, and/or a combination thereof.

Also, it is noted that portions of the embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in the figure. A process can correspond to a method, a function, a procedure, a subroutine, a subprogram, etc. When a process corresponds to a function, its termination corresponds to a return of the function to the calling function or the main function.

Furthermore, embodiments can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware and/or software implementation, the methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium”, “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A computer-implemented method, comprising:
accessing an interface, wherein the interface is configured to interact with one or more profiles, and wherein a profile is associated with a social media network;
detecting an interaction between the interface and a profile, wherein the profile indicates a connection to one or more additional profiles;
accessing activity data associated with the one or more additional profiles, wherein the activity data is associated with an attribute corresponding to the one or more additional profiles, and wherein the attribute is associated with the social media network;
determining an interaction protocol using the activity data, wherein the interaction protocol is configured to increase a likelihood of an outcome, wherein the outcome targets an additional profile of the one or more additional profiles, and wherein the additional profile is associated with the attribute; and
facilitating a communication according to the interaction protocol.

2. The computer-implemented method of claim 1, wherein the interaction protocol is associated with a characteristic, and wherein facilitating the communication includes transmitting the communication according to the characteristic.

3. The computer-implemented method of claim 1, wherein determining the interaction protocol includes evaluating the activity data to select at least one additional profile from the one or more additional profiles, and wherein the selected at least one additional profile is a target for the communication.

4. The computer-implemented method of claim 1, wherein the interaction protocol includes a workflow for communicating with the additional profile.

5. The computer-implemented method of claim 1, wherein the outcome is interacting with the interface associated with the client device.

6. The computer-implemented method of claim 1, wherein determining the interaction protocol includes generating a plurality of interaction protocols using the activity data, and wherein communication approaches for two or more interaction protocols differ from each other.

7. The computer-implemented method of claim 1, wherein the interaction corresponds to associating the profile to the client device using the interface.

8. A system, comprising:
one or more data processors; and
a non-transitory computer-readable storage medium containing instructions which, when executed on the one or more data processors, cause the one or more data processors to perform operations including:
accessing an interface, wherein the interface is configured to interact with one or more profiles, and wherein a profile is associated with a social media network;
detecting an interaction between the interface and a profile, wherein the profile indicates a connection to one or more additional profiles;
accessing activity data associated with the one or more additional profiles, wherein the activity data is associated with an attribute corresponding to the one or more additional profiles, and wherein the attribute is associated with the social media network;
determining an interaction protocol using the activity data, wherein the interaction protocol is configured to increase a likelihood of an outcome, wherein the outcome targets an additional profile of the one or more additional profiles, and wherein the additional profile is associated with the attribute; and
facilitating a communication according to the interaction protocol.

9. The system of claim 8, wherein the interaction protocol is associated with a characteristic, and wherein facilitating the communication includes transmitting the communication according to the characteristic.

10. The system of claim 8, wherein determining the interaction protocol includes evaluating the activity data to select at least one additional profile from the one or more additional profiles, and wherein the selected at least one additional profile is a target for the communication.

11. The system of claim 8, wherein the interaction protocol includes a workflow for communicating with the additional profile.

12. The system of claim 8, wherein the outcome is interacting with the interface associated with the client device.

13. The system of claim 8, wherein determining the interaction protocol includes generating a plurality of interaction protocols using the activity data, and wherein communication approaches for two or more interaction protocols differ from each other.

14. The system of claim 8, wherein the interaction corresponds to associating the profile to the client device using the interface.

15. A computer-program product tangibly embodied in a non-transitory machine-readable storage medium, including instructions configured to cause a data processing apparatus to perform operations including:
accessing an interface, wherein the interface is configured to interact with one or more profiles, and wherein a profile is associated with a social media network;
detecting an interaction between the interface and a profile, wherein the profile indicates a connection to one or more additional profiles;
accessing activity data associated with the one or more additional profiles, wherein the activity data is associated with an attribute corresponding to the one or more additional profiles, and wherein the attribute is associated with the social media network;
determining an interaction protocol using the activity data, wherein the interaction protocol is configured to increase a likelihood of an outcome, wherein the outcome targets an additional profile of the one or more additional profiles, and wherein the additional profile is associated with the attribute; and
facilitating a communication according to the interaction protocol.

16. The computer-program product of claim 15, wherein the interaction protocol is associated with a characteristic, and wherein facilitating the communication includes transmitting the communication according to the characteristic.

17. The computer-program product of claim 15, wherein determining the interaction protocol includes evaluating the activity data to select at least one additional profile from the one or more additional profiles, and wherein the selected at least one additional profile is a target for the communication.

18. The computer-program product of claim 15, wherein the interaction protocol includes a workflow for communicating with the additional profile.

19. The computer-program product of claim 15, wherein the outcome is interacting with the interface associated with the client device.

20. The computer-program product of claim 15, wherein determining the interaction protocol includes generating a plurality of interaction protocols using the activity data, and wherein communication approaches for two or more interaction protocols differ from each other.
